(19) United States
(12) Patent Application Publication
(10) Pub. No.: US 2014/0012628 A1
(43) Pub. Date: Jan. 9, 2014

(54) ESTIMATING WHOLESALE DEMAND FOR CONSUMER PRODUCTS

(71) Applicant: Lux Delux, San Francisco, CA (US)

(72) Inventor: Andrew Hsieh, San Francisco, CA (US)

(73) Assignee: Lux Delux, San Francisco, CA (US)

(21) Appl. No.: 13/950,283

(22) Filed: Jul. 25, 2013

Related U.S. Application Data
(63) Continuation-in-part of application No. 13/935,340, filed on Jul. 3, 2013.
(60) Provisional application No. 61/842,964, filed on Jul. 3, 2013.
(60) Provisional application No. 61/667,863, filed on Jul. 3, 2012.

(51) Int. Cl. G06Q 30/02

(52) U.S. Cl. CPC G06Q 30/0202
USPC 705/7.31

(57) ABSTRACT

A system and a method are disclosed for providing buyers of products with a customized list of products for sale that meet the buyers' criteria, capturing buyers' interactions with the products and analyzing the product's popularity based on the interactions.

### RELATED APPLICATIONS

This application claims the benefit of the filing date of U.S. Provisional Application 61/842,964 filed Jul. 3, 2013 and is a continuation-in-part of U.S. application Ser. No. 13/935,340 filed Jul. 3, 2013 which claims the benefit of the filing date of U.S. Provisional Application 61/667,863 filed Jul. 3, 2012, all of which are hereby incorporated by reference in their entirety.

### BACKGROUND

1. Field of Art

The disclosure generally relates to the field of estimating demand for consumer products and services.

2. Description of the Related Art

Conventionally, producers of consumer products and providers of consumer services use focus groups to assess the popularity of a product and thus assess how many units should be produced. Additionally, selected buyers for retail outlets are also surveyed. However, in both instances, the validity of the gathered data still assumes that the surveyed panelists are a fair representation of their groups, end-user consumers and retail buyers. Additionally, this data is gathered at one point in time and does not show change in attitude over time unless additional surveys are completed later. There remains a need for gathering and analyzing information about consumer products and services that is generated from larger groups of individuals such as in environments that bring specialized or large-scale buyers and sellers together, for example, trade shows. There further is a need to gather and analyze the data in such settings in real time such that trends in popularity are determined.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system architecture for a product demand estimation system.

FIG. 2 illustrates a sequence of events for the product demand estimation system according to one embodiment.

FIG. 3 illustrates a log-in user interface for vendor users according to one embodiment.

FIG. 4 illustrates the account creation user interface according to one embodiment.

FIG. 5 illustrates a user interface for vendors to invite other users according to one embodiment.

FIG. 6 illustrates a user interface for vendors to identify other users to invite according to one embodiment.

FIG. 7 illustrates a user interface for buyer users to log in to the system according to one embodiment.

FIG. 8 illustrates a user interface for buyer users to create an account on the system according to one embodiment.

FIG. 9 illustrates a user interface for buyer users to use a social network account to connect to their contacts at the event.

FIG. 10 illustrates a user interface for buyer users to select contacts from a social network with whom to connect at the event according to one embodiment.

FIG. 11 illustrates a user interface for the buyer providing trending products for the buyer.

FIG. 12 illustrates a user interface for the buyer to update preferences for filtering the products shown according to one embodiment.

FIG. 13 illustrates a user interface after a buyer has selected criteria for filtering products for display according to one embodiment.

FIG. 14 illustrates the user interface showing the products after the preferences are updated according to one embodiment.

FIG. 15 illustrates a list of all vendors at the event according to one embodiment.

FIG. 16 illustrates a floor plan of vendor locations according to one embodiment at the location.

FIG. 17 illustrates a user interface that shows detail about a particular vendor according to one embodiment.

FIG. 18A illustrates a user interface for a buyer user showing detailed information about a product according to one embodiment.

FIG. 18B illustrates a user interface displaying additional details about a product according to another embodiment.

FIG. 19 illustrates the data flow for determination of the vendor specific metrics according to one embodiment.

FIG. 20 illustrates a user interface for a vendor user of the product demand estimation system dashboard for vendors according to one embodiment.

FIG. 21 illustrates a user interface for a vendor user of the product demand estimation system dashboard for vendors according to another embodiment.

FIG. 22 illustrates a more detailed version of graph 2153 according to one embodiment.

FIG. 23 illustrates that a user can update graph 2153 to show interactions for different time periods according to one embodiment.

FIG. 24 illustrates a more detailed version of graph 2155 according to one embodiment.

FIG. 25 illustrates a more detailed version of interactions of individual buyers of each gender according to one embodiment.

FIG. 25 illustrates a longer list of popular products according to one embodiment.

FIG. 26 illustrates a more detailed view of popular products according to one embodiment.

FIG. 27 illustrates a user interface for editing products by a vendor according to one embodiment.

FIG. 28 illustrates a user interface for a vendor user showing detailed data and analysis for one of the vendor's products according to one embodiment.

FIG. 29 illustrates a user interface for a vendor user showing detailed data and analysis for one of the vendor's products according to another embodiment.

FIG. 30 illustrates a user interface for a vendor to compare multiple products according to one embodiment.

FIG. 31 illustrates creation of a campaign according to one embodiment.

FIG. 32 illustrates inviting buyers to a campaign according to one embodiment.

FIG. 33 illustrates a user interface for filtering possible buyers for inviting to a campaign according to one embodiment.

FIG. 34 illustrates the user interface for finalizing creation of a campaign according to one embodiment.

FIG. 35 illustrates a user interface showing status of campaigns according to one embodiment.

### SUMMARY

A system (and a method) are disclosed to estimate demand for a product real-time at an event, e.g., in a trade show, a farmers market, flea market, or other environments where products may be shown and market data may be desired to evaluate demand. The system is configured to provide details of products on a computing device, e.g., in advance of the event. The system receives information corresponding to interactions on the computing device by buyers with the product for which demand information is sought. In this configuration, the system receives at least one piece of demographic information about each buyer and determines estimated demand for the product based on the interactions and the at least one piece of demographic information. The demographic information about the buyer is used to determine a level of influence the buyer has.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In one embodiment, a system (and a method) are disclosed to estimate demand for a product real-time at an event, e.g., in a trade show, a farmers market, flea market, or other environments where products may be shown and market data may be desired to evaluate demand. The system is configured to provide details of products on a computing device, e.g., in advance of the event. The system receives information corresponding to interactions on the computing device by users with the product for which demand information is sought. In this configuration, the system receives at least one piece of demographic information about each user and determines estimated demand for the product based on the interactions and the at least one piece of demographic information.

In some embodiments the demographic information about the buyer is used to weight the interactions by that buyer in determining the estimated demand for the product. Optionally, demographic information about the company the buyer is representing is also received and used to weight the buyer's interactions. The estimated demand may in the form of a total monetary amount expected for all sales or a total number of sales expected. The estimated demand can be determined for a product, a subset of products, or a product line. In some embodiments, vendors create campaigns encompassing a subset of products.

### Architectural Overview

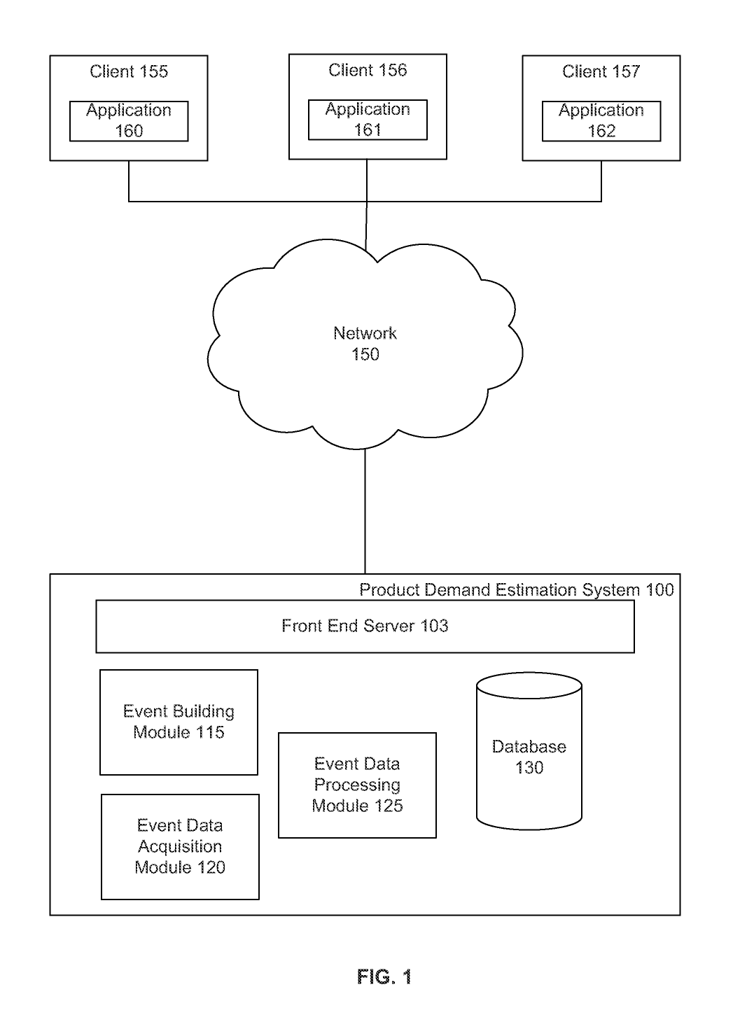

FIG. 1 illustrates an embodiment of the system architecture for a product demand estimation system 100 (“system 100”). The system 100 comprises a front end server 103, event building module 115, event data acquisition module 120, an event data processing module 125 and a database 130. The system 100 communicates with clients 155 and 156 via a network 150. For simplicity, only one of each client 155, 156 and 157 are shown. However, in practice there will be numerous clients 155, 156 and 157 communicating with the system 100. Similarly, only one system 100, front end server 103, event building module 115, event data acquisition module 120, an event data processing module 125 and a database 130 are shown. In practice there will be many of each of these in operation.

The clients 155, 156 and 157 can be any type of computing device that is adapted to access the system 100 via the front end server 103 over the network 150. Client 155 is a buyer client 155 device, client 156 is a vendor client 156 device and client 157 is an event organizer client 157. Examples include, but are not limited to, desktop computers as well as portable computing devices such as laptops, tablet computers, smartphones, etc. Application 160 at the client 155 is a user interface used by the buyer to access the system 100. Application 161 at the client 156 is a user interface used by the vendor to access the system 100. Application 162 at the client 157 is a user interface used by the event organizer to access the system 100. In one embodiment, applications 160, 161 and 162 are browsers.

The event building module 115 receives data from a user about an event as well as receiving data from vendors at an event about the vendor's products and stores the received data in the database 130. In some embodiments, the database 130 is a nosql database. The operation of the event building module 115 is described in greater detail below. The event data acquisition module 120 receives data acquired during an event from users attending the event and vendor users at the event and stores the data in the database 130. The operation of the event data acquisition module 120 is described in greater detail below. The event data processing module 125 analyzes the data received by the event data acquisition module 120 and provides the analysis to vendor users, buyer users and event organizer users. The operation of the event data processing module 125 is described in greater detail below.

The network 150 through which the client 155 and system 100 communicate can be any type of network, wired or wireless, known in the art. Examples include the Internet, but may also be any network, including but not limited to a LAN, a MAN, a WAN, an 802.11 network, an 802.16 network, a mobile, wired or wireless network, telecommunication network, a private network, or a virtual private network, and any combination thereof.

### Building an Event

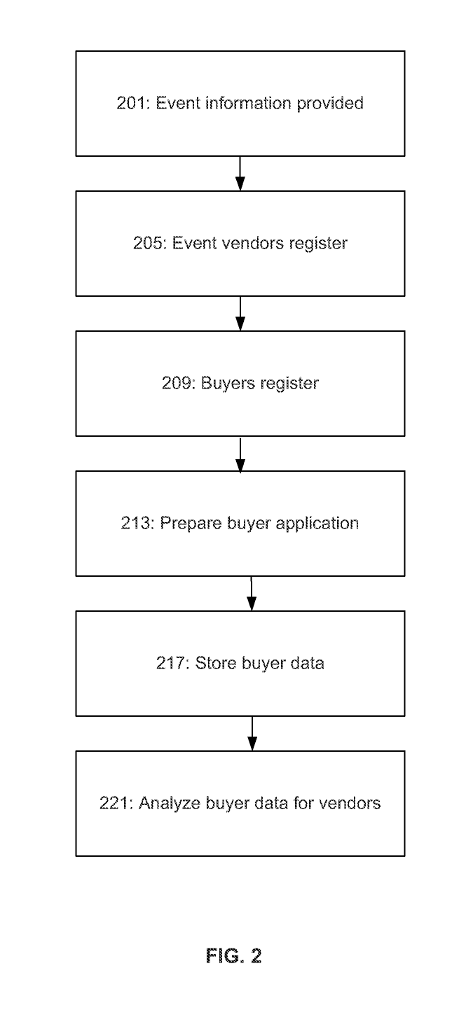

Referring now to FIGS. 2-, the building of an event is described. For example, an event may be an electronics trade show at which vendors display products such as televisions, stereos, cameras, computers, printers, cell phones, etc. A user provides 201 to the event building module 115, the event's metadata such as the dates of the event, schedule, vendors displaying at the event, location, driving directions, opening hours, etc. Optionally, lists of categories of products and keywords for products are populated for selection by the event vendors when adding their products to the database 130. For example, for the category cameras, keywords for selection by vendors could include SLR, 10× optical zoom, 15× digital zoom, 5× optical zoom, compact, water-proof, shock-proof, 12 megapixels (MP), etc. In other embodiments, vendors provide keywords and products in free response style during the vendor registration described below.

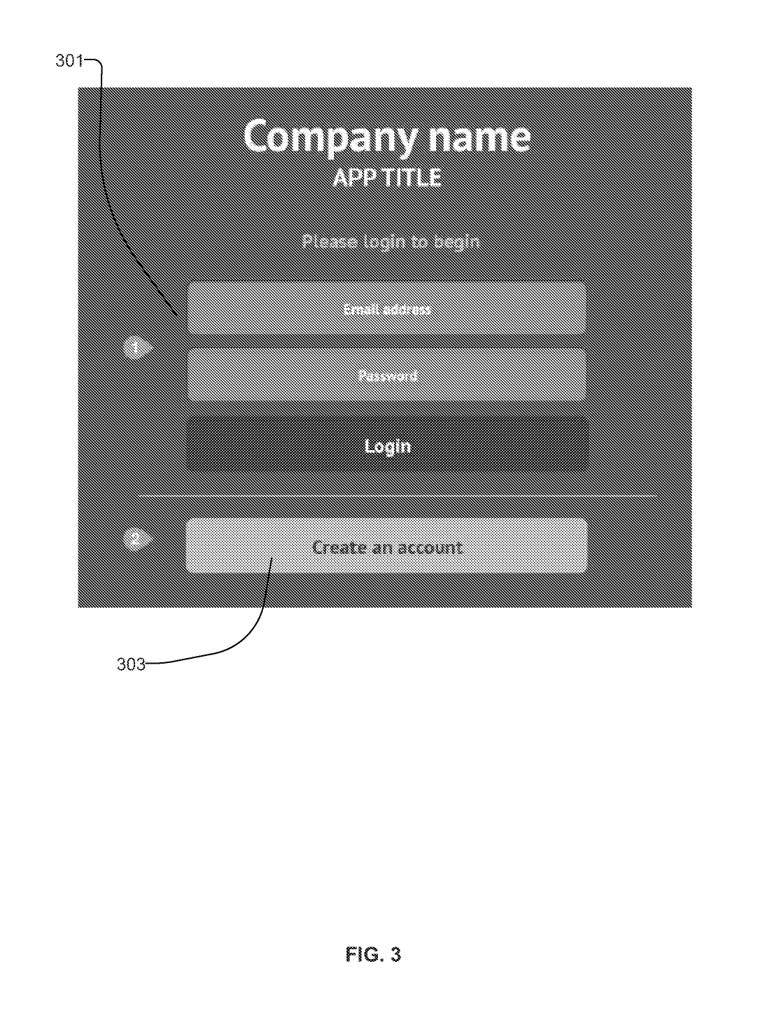

After the event has been built, both vendor users and buyer or attendee users register for the event. FIG. 3 illustrates a log-in user interface for vendor users according to one embodiment. At 301, vendor users enter a username, which in this embodiment is an email address, and a password, if the vendor user is already registered with the system 100. In some embodiments, users who have already registered with the system 100 log in via credentials for a social network such as, for example, LINKEDIN™, FACEBOOK™, etc. If not, the vendor user uses button 303 to create an account.

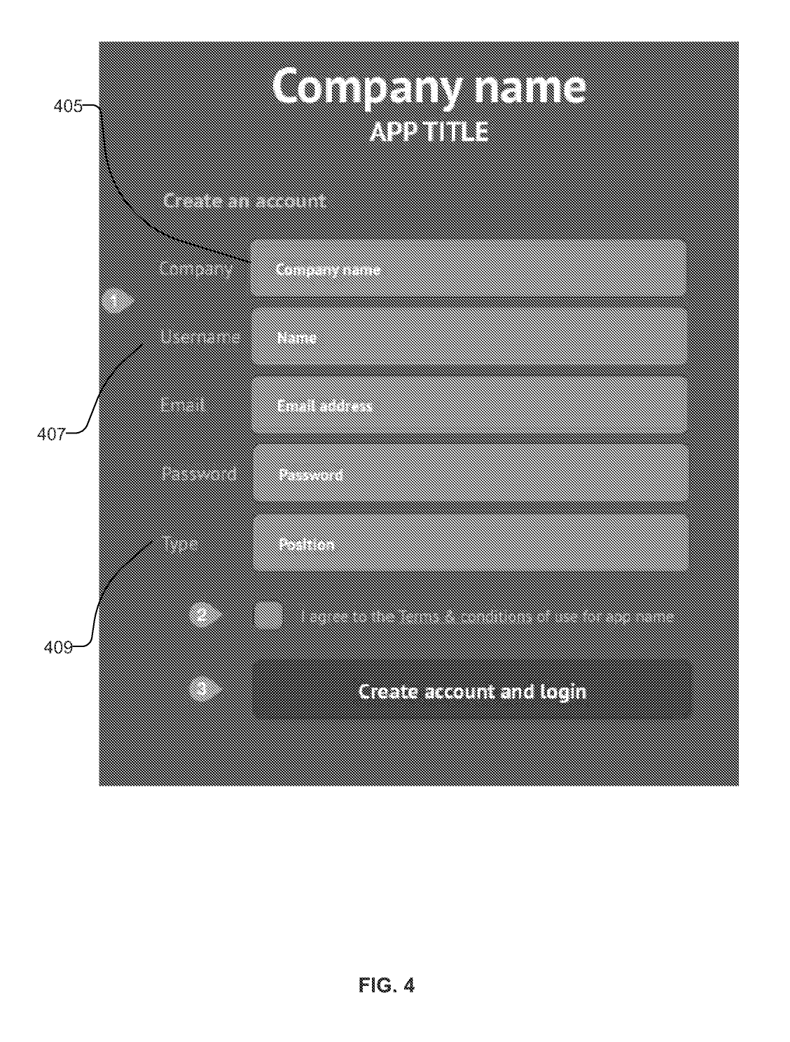

FIG. 4 illustrates the account creation user interface according to one embodiment. In this user interface, the vendor user is the first user to create an account associated with a vendor company and enters the information about the vendor company 405 as well as the vendor user 407. Information about the vendor user includes the vendor user's position 409 with the vendor company. Multiple individuals can be vendor users associated with a vendor company. Thus, if a vendor company sends multiple employees to a particular tradeshow, each employee has his or her own vendor user account.

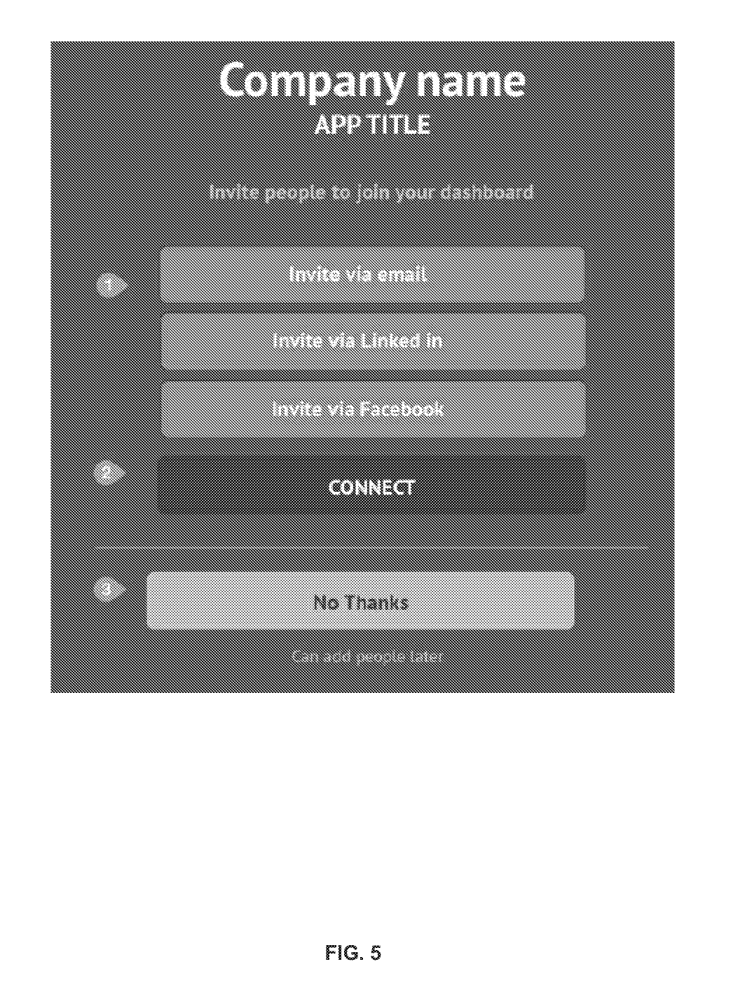

FIG. 5 illustrates a user interface for a vendor user to add other individuals associated with the vendor company to create a vendor user account associated with the vendor company according to one embodiment. Vendor users can invite the other users using the other users' email address or selecting individuals to whom the vendor user is connected in a social network.

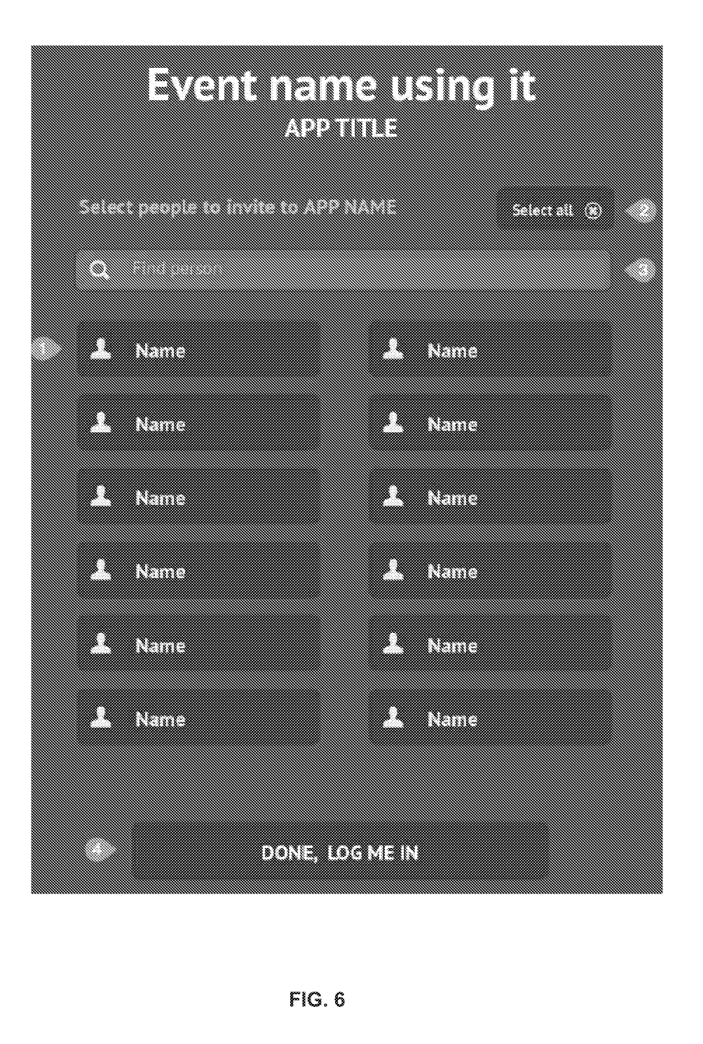

FIG. 6 illustrates a user interface for vendors to identify other users to invite according to one embodiment. During registration 205, vendor users provide details about the products or services offered at the event. Details include the product or service's name, category, type, description, color, size, duration, price, photos, promotional offers etc. For different types of products and services, different details are relevant. Size and color are more likely to be relevant to a product for example. Example details for cameras include one or more photos of each camera, pricing (including promotional pricing if the vendor is providing volume discounts), detailed product information about each camera (number of megapixels, optical and digital zoom distances, camera weight and dimensions, type of memory card, etc.) as well as information relevant to a retail seller of the cameras such as how much notice is required for delivery of various quantities of cameras. For example, how many months in advance does an order need to be placed for 100 units to be in the retail store for the holiday shopping season? Optionally, the vendor user provides to the system 100 sample terms and conditions for retail purchasers of the products. In some embodiments, vendors can choose to accept orders at the event. Vendors can also provide a calendar of appointments when the vendor is available to meet with buyers.

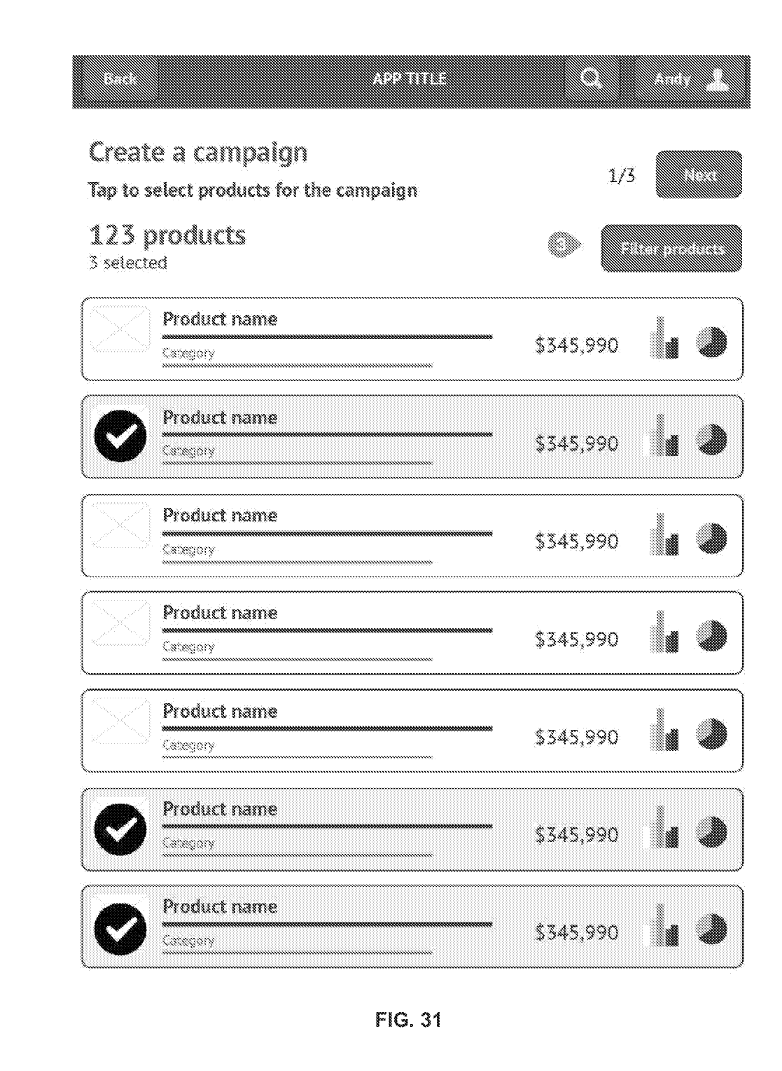

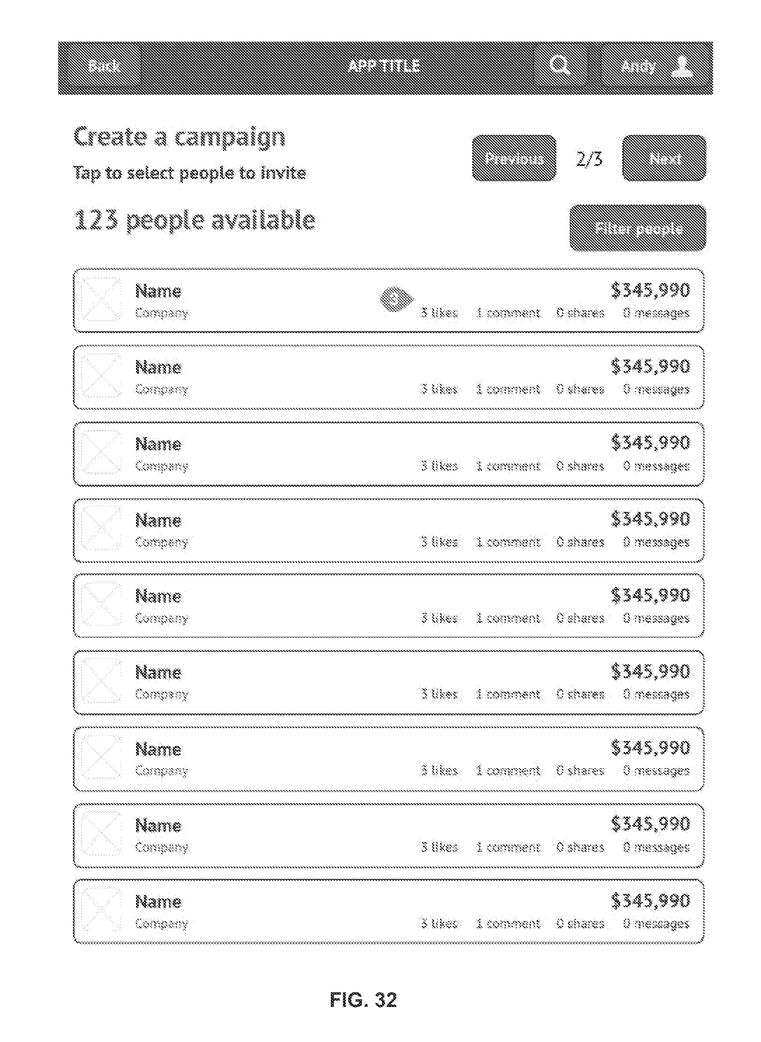

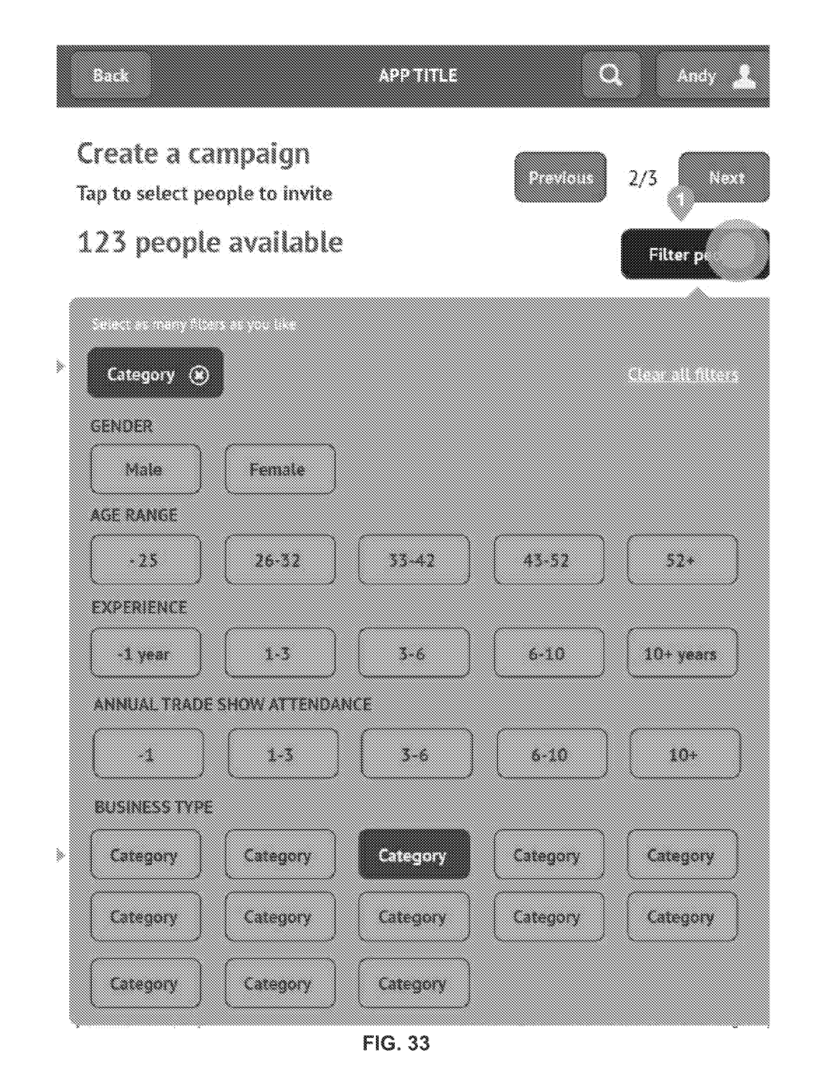

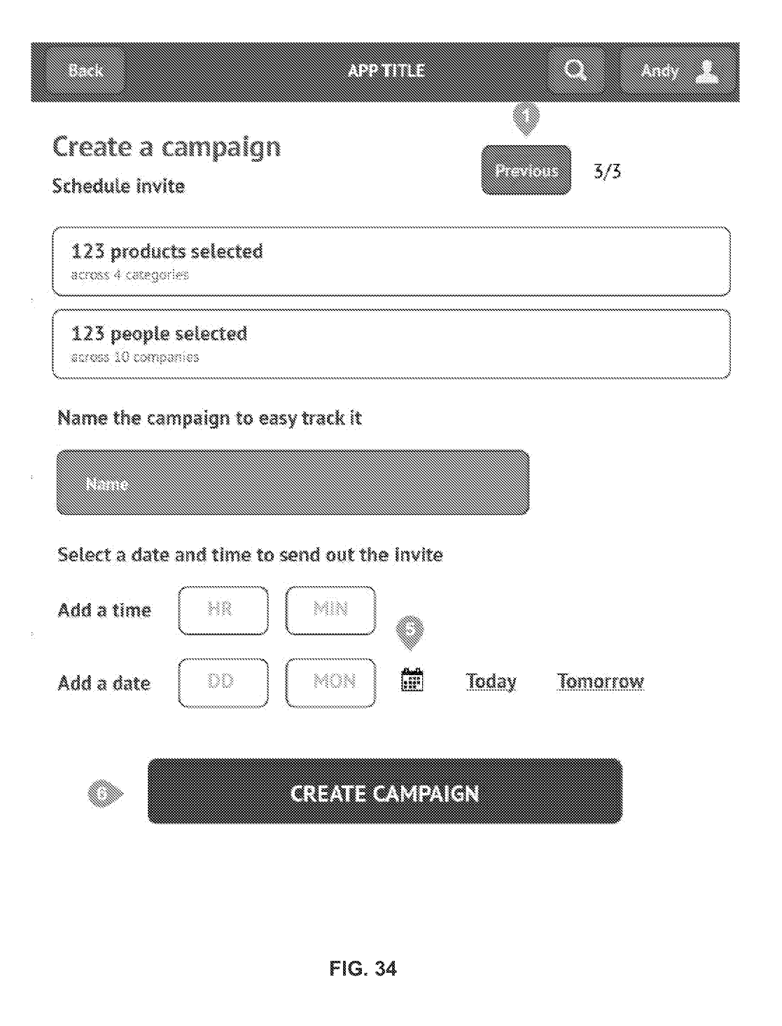

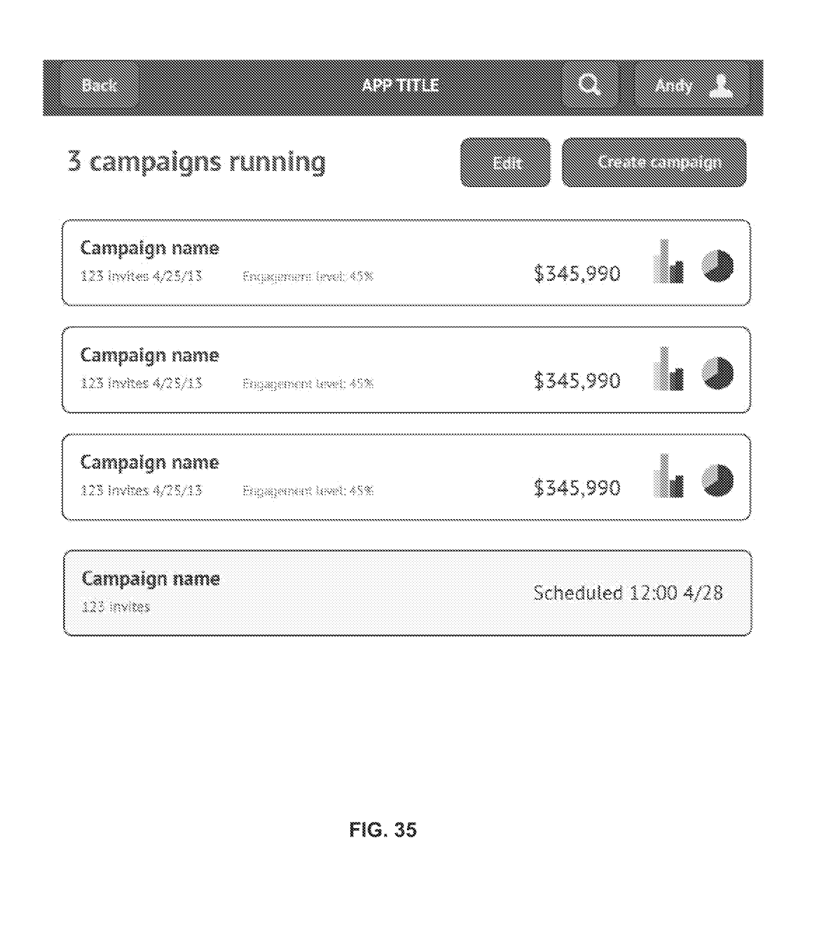

In some embodiments, vendors can create campaigns around one or more of their products. As shown in FIG. 31, a vendor selects products from their list of products to include in the campaign. In some embodiments, the campaign is only available to some buyers and not others. In such an embodiment, the vendor selects the buyers to invite to the campaign. FIG. 32 demonstrates the selection of buyers to invite. FIG. 33 illustrates a user interface for the vendor to filter buyers by demographics prior to selecting individual buyers to invite. FIG. 34 illustrates the user interface finalizing creation of a campaign including selection of time and date to send out invitation. A vendor can view launched campaigns and the degree of engagement by buyers with each as illustrated in FIG. 35. Created campaigns that have not yet launched are also shown.

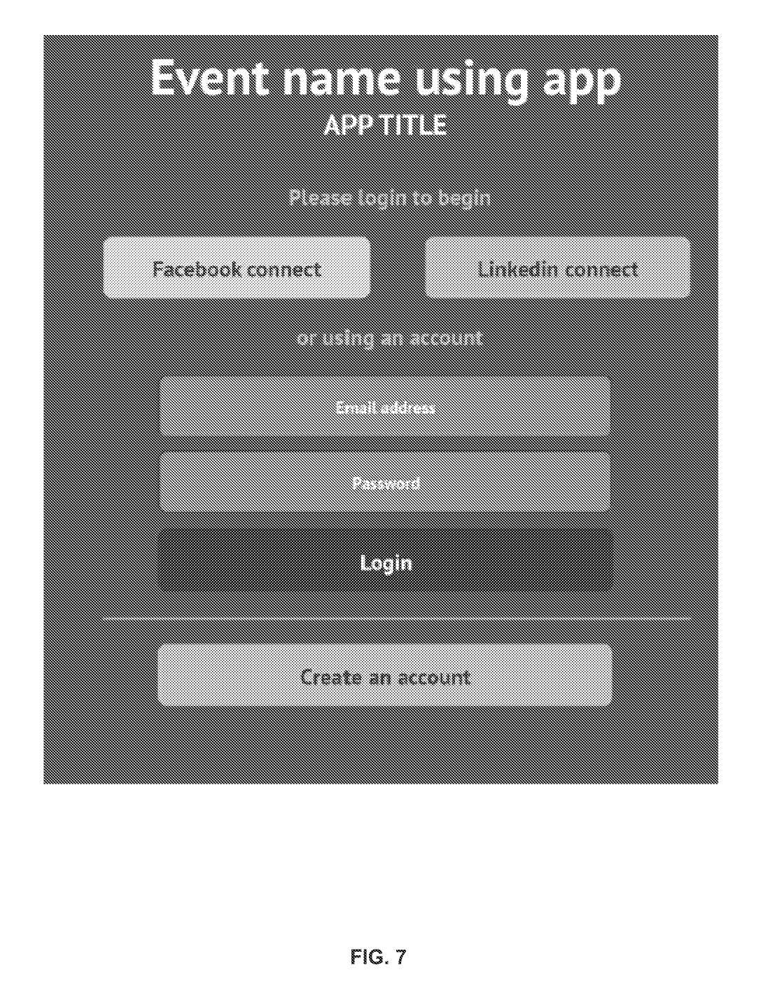

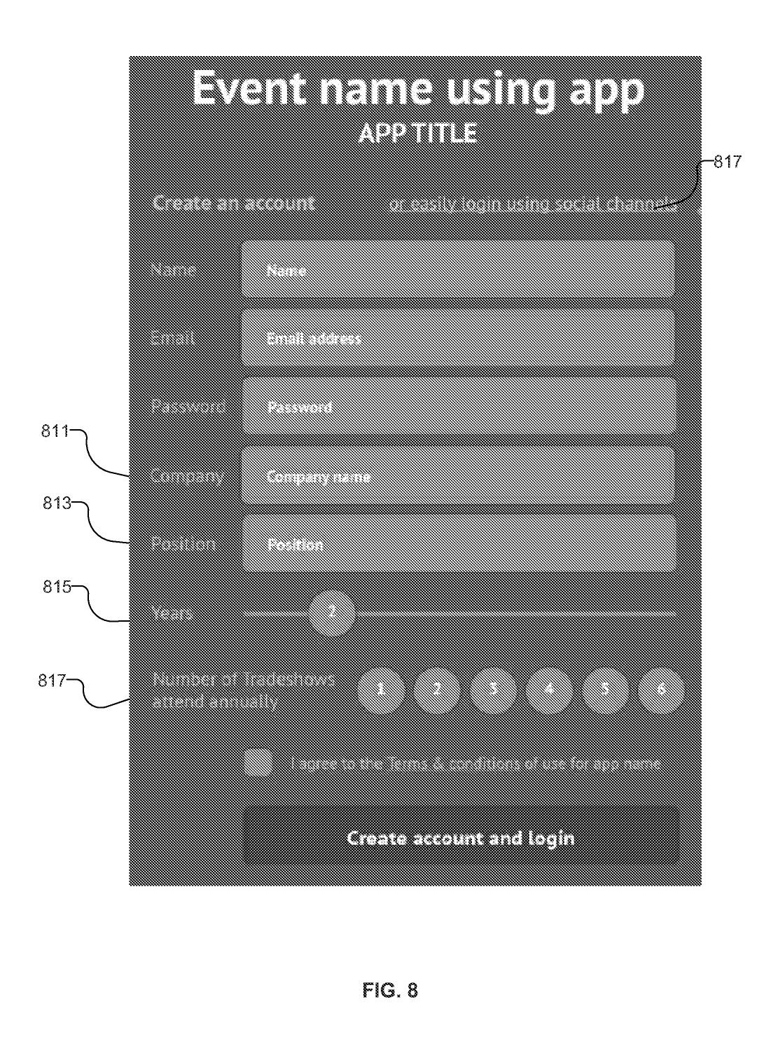

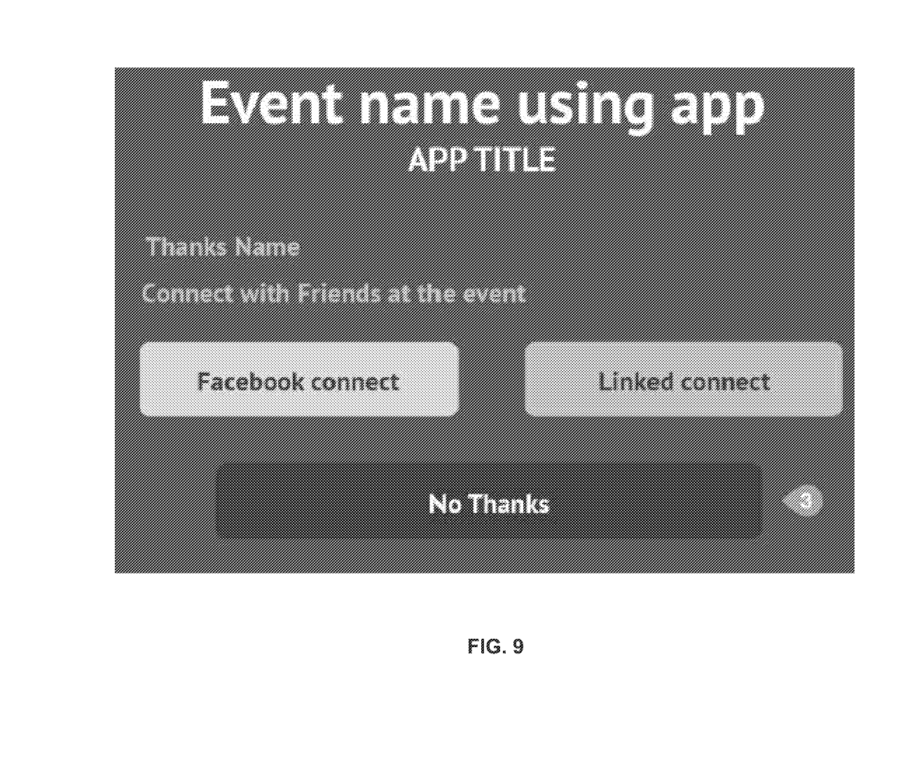

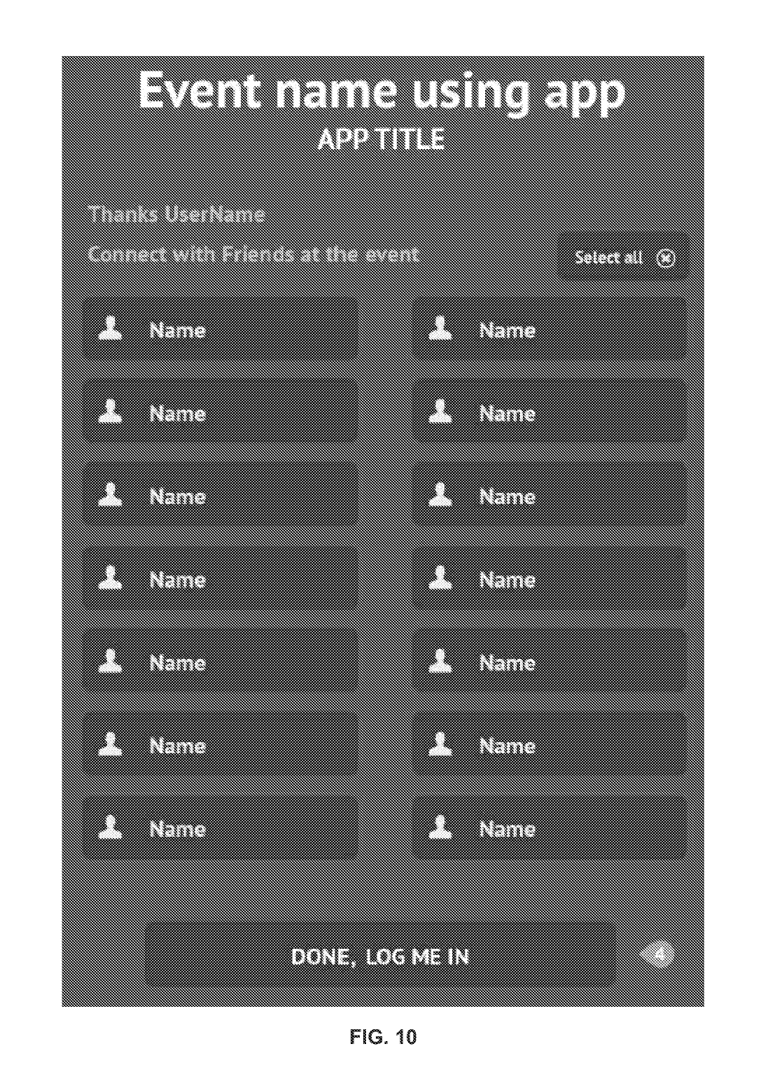

Buyer or attendee users (“buyers”) also register 205. FIG. 7 illustrates a user interface for buyer users to log in to the system according to one embodiment. FIG. 8 illustrates a user interface for buyer users create an account according to one embodiment. The user provides not only name, username and password but also the company 811 the buyer represents. For simplicity, the company the buyer represents may be referred to in this disclosure as the buyer's employer. This is for simplicity and does not require that a buyer actually be an employee of the company they represent a buyer could represent a company without being an employee of the company. Additionally information includes the buyer's position 813 at the company 811, number of years 815 at the company, how many tradeshows the buyer attends in a given period 817 (for example per year or per month), etc. A buyer user can also choose to create their account via the login information they use for an existing social networking account using the link at 819. If a user uses an existing social networking account to log in to the system 100, any information needed for the account with the system 100 available from the social networking account will be pre-populated in those fields. For example, the buyer's social networking account may include the buyer's employer, position with the employer and number of years the buyer has been with the employer. Buyers can choose to connect with their contacts in social networks. FIG. 9 illustrates a user interface for buyer users to use a social network account to connect to their contacts at the event. FIG. 10 illustrates a user interface for buyer users to select contacts from a social network with whom to connect at the event according to one embodiment.

In some embodiments, buyer users provide information about the company they represent. Demographic information about the company the buyer represents includes the size of the company, the number of stores the company has if it's a retailer, sales volume, price point, and company type. Buyers also provide information specific to the event the buyer is attending. For example, the buyer identifies what the buyer is interested in at the tradeshow (particular products or services). About the items of interest, the buyer selects not only categories but also their requirements for particular features in products.

In some embodiments, the buyers can indicate how important certain features are. In an example of cameras, the buyer may be interested in high megapixels but also wants an optical zoom in addition to a digital zoom. The buyer can indicate if the two features are equally important or if one is more important than the other. In the example of an electronics show, buyers for specialty camera shops are more likely to be looking to purchase cameras with optical zooms and single lens reflex cameras. Buyers for big box electronics stores are more likely to be interested in a range of cameras from pocket-size fully automated cameras to single lens reflex cameras in addition to other electronics. Additionally, the buyers can enter what volume they are looking to purchase and when they would be looking to receive the various items. This information is useful in providing the buyer with customized information when the buyer arrives at the event. The buyer can rank the categories of products the buyer is interested in purchasing by importance. For example, purchasing cameras may be of primary importance to the buyer for this event but televisions are also of interest but secondarily.

Once a buyer has registered with the system 100, the buyer's account information is stored in the database 130 and the buyer does not need to re-register when attending another event at which the 100 is used. When the buyer logs in to a new event, the system 100 may ask the buyer to update event-specific information.

### Build Buyer Application

The event building module 115 prepares 213 an application 160 to guide buyers through the event using the information provided by the buyers and the vendors. The application 160 resides on a client 155 device. In some embodiments, the client 155 devices are dedicated client 155 devices that buyers receive upon arriving at an event. For example, such dedicated client 155 devices may be tablet computers preloaded with the buyer's application 160.

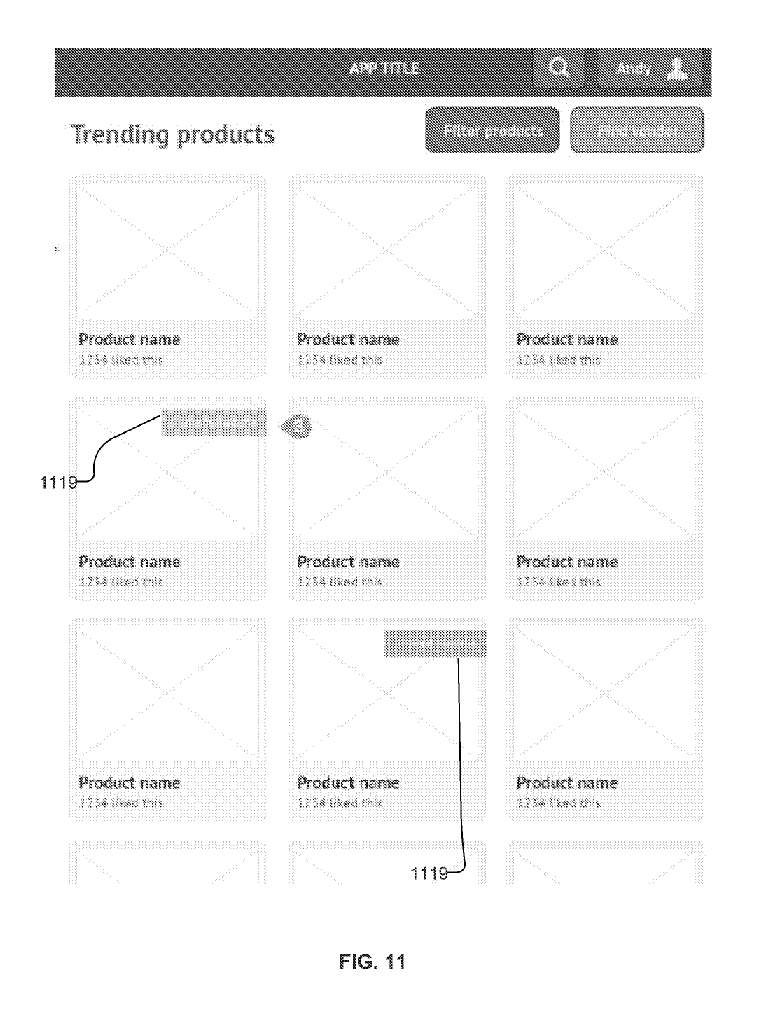

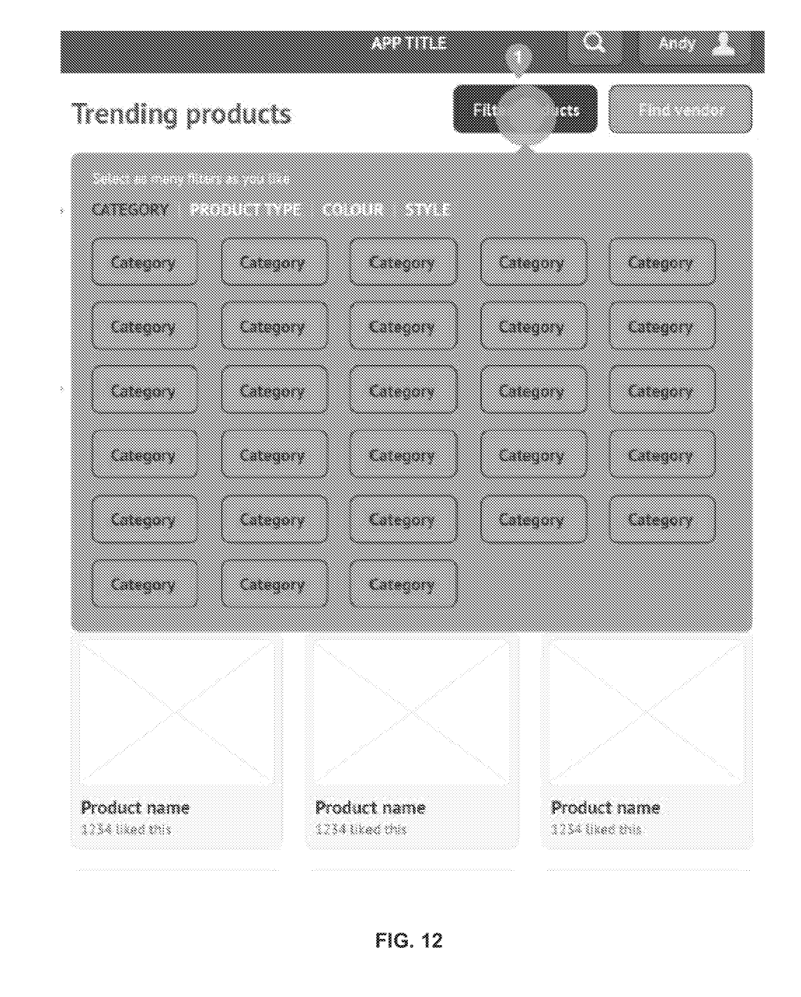

In preparing the application 160 for each buyer, the event building module 115 filters the inventory of products provided by the vendors using the buyer's preferences provided when registering. FIG. 11 illustrates a user interface for the buyer providing trending products for the buyer. In this example, the buyer as chosen to connect with contacts from a social networking application and the user interface points out items that have been “liked” by the buyer's contacts. FIG. 12 illustrates a user interface for the buyer to update preferences for filtering the products shown according to one embodiment. The user selects one or more criteria in each of “category,” “product type,” “color,” and “style” as filters. The types of criteria are determined by the products or services at the trade show. If the trade show is for books, “color” and “style” are likely to be less relevant and the criteria instead would be “genre,” “prize winner,” etc.

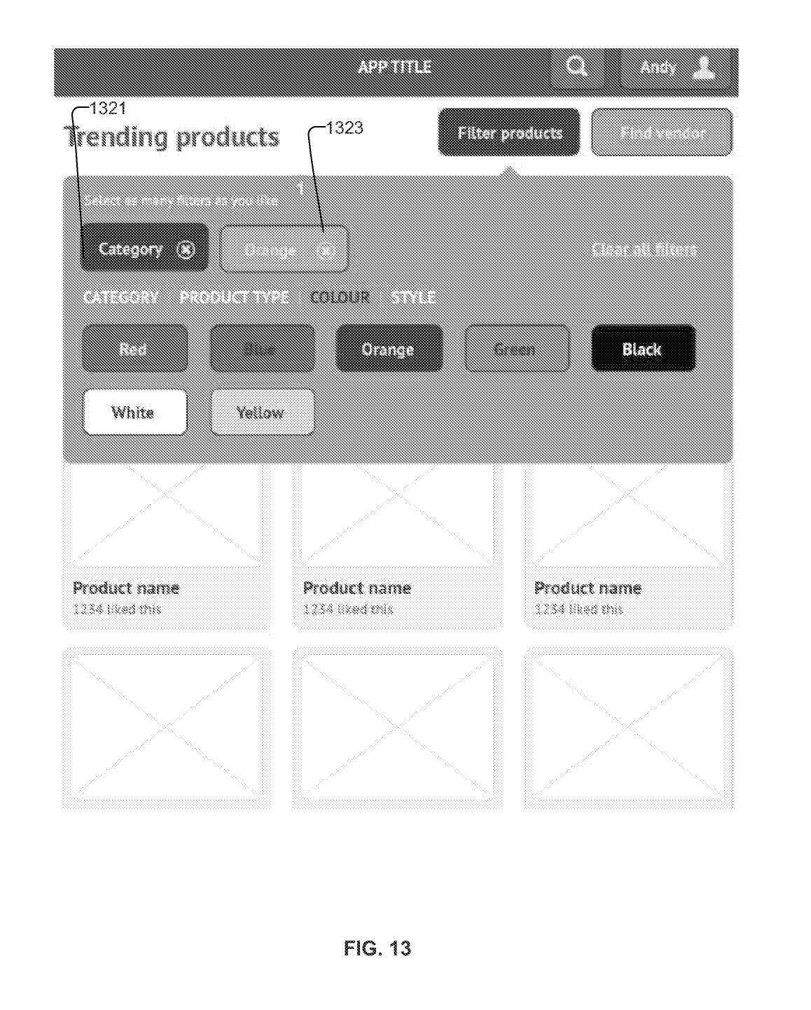

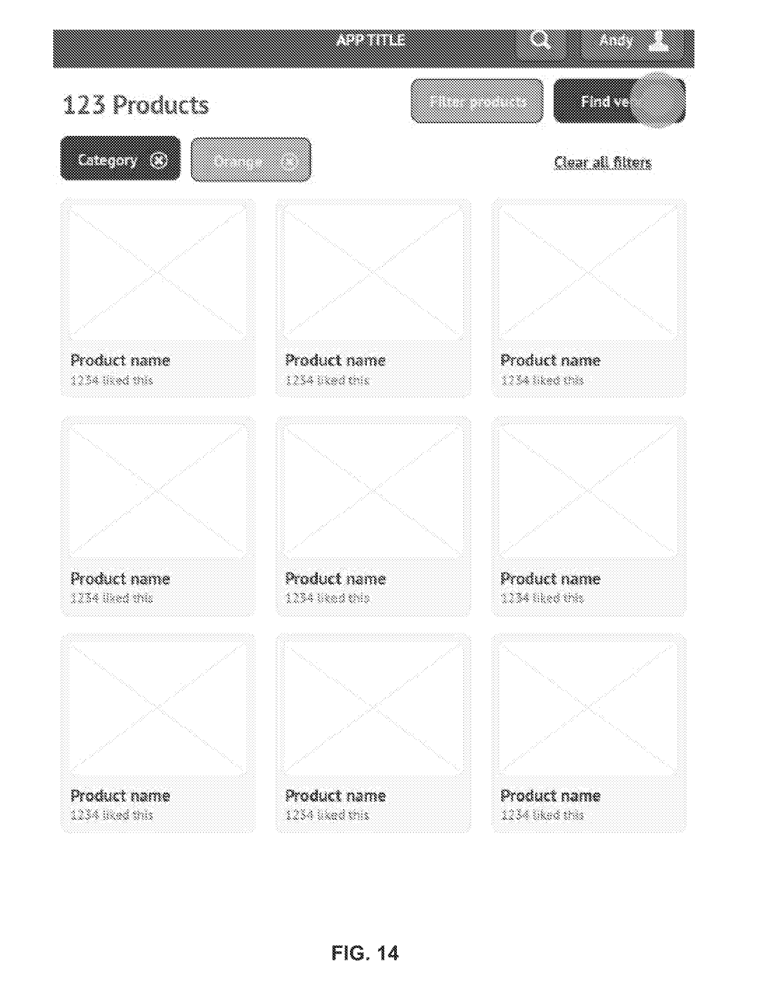

FIG. 13 illustrates a user interface after a buyer has selected criteria for filtering products for display according to one embodiment. In this example, the buyer selected one category 1321 and one color 1323 for filtering products. After submitting the updated preferences, the listed products are updated using the preferences. FIG. 14 illustrates the user interface showing the products after the preferences are updated according to one embodiment. The determination of which products are trending is described in greater detail below.

In some embodiments, instead filtering the list based on the preferences provided at registration, the entire inventory is loaded in the buyer's application 160. Using information provided at registration and then in later updates to preferences, the application 160 provides to the buyer information on the products of greatest interest to them at the event. This allows the buyers to examine products via the application 160 as well as in person visiting vendors at booths.

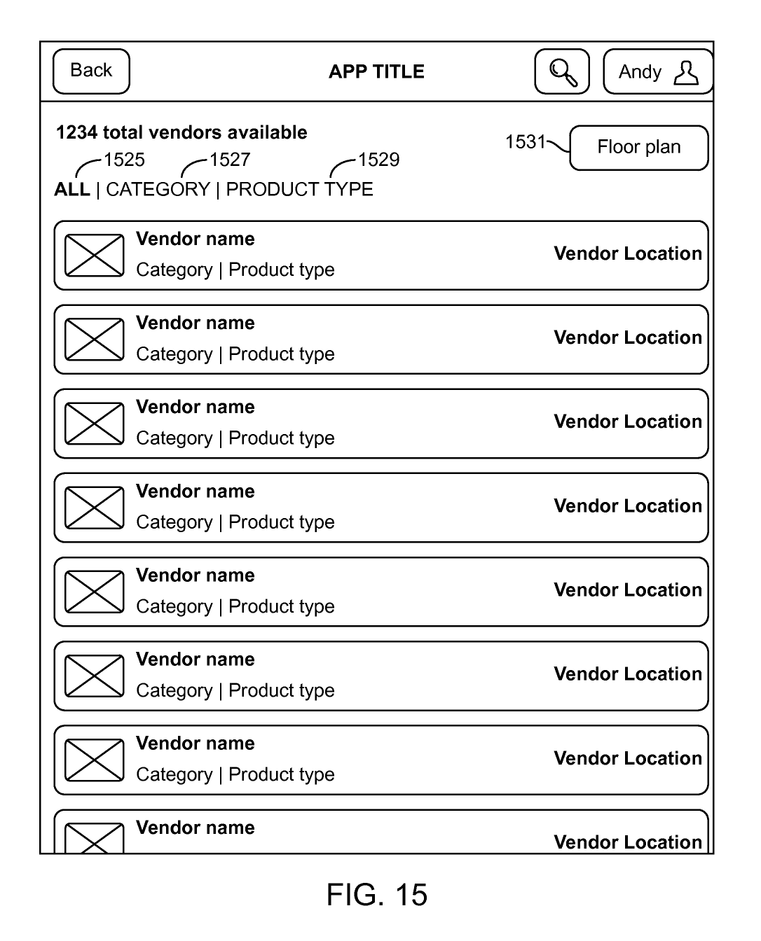

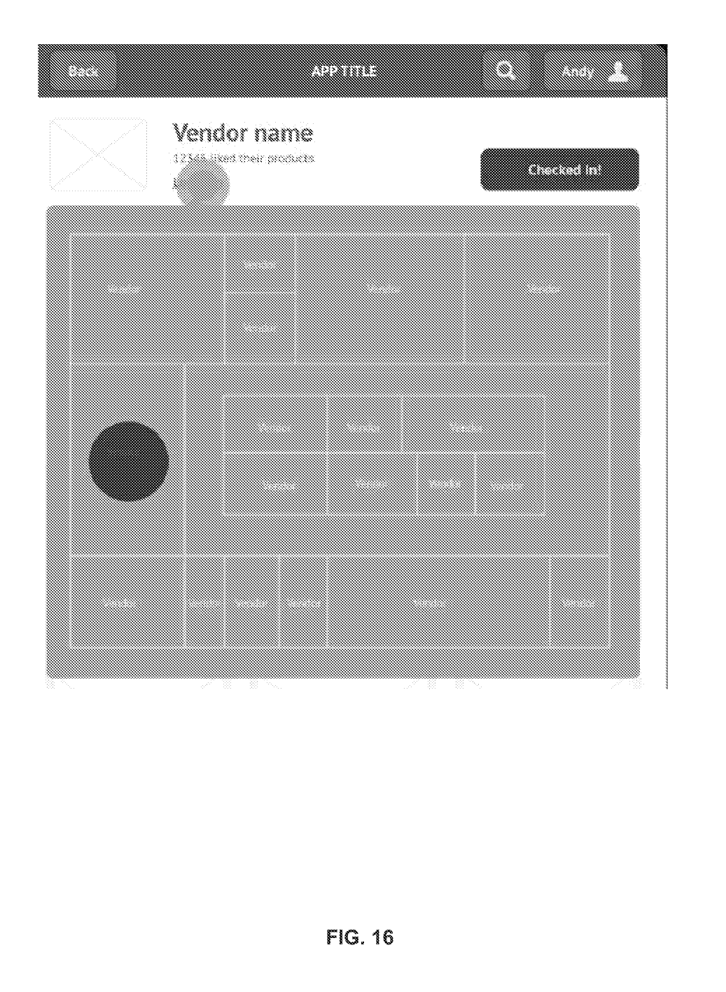

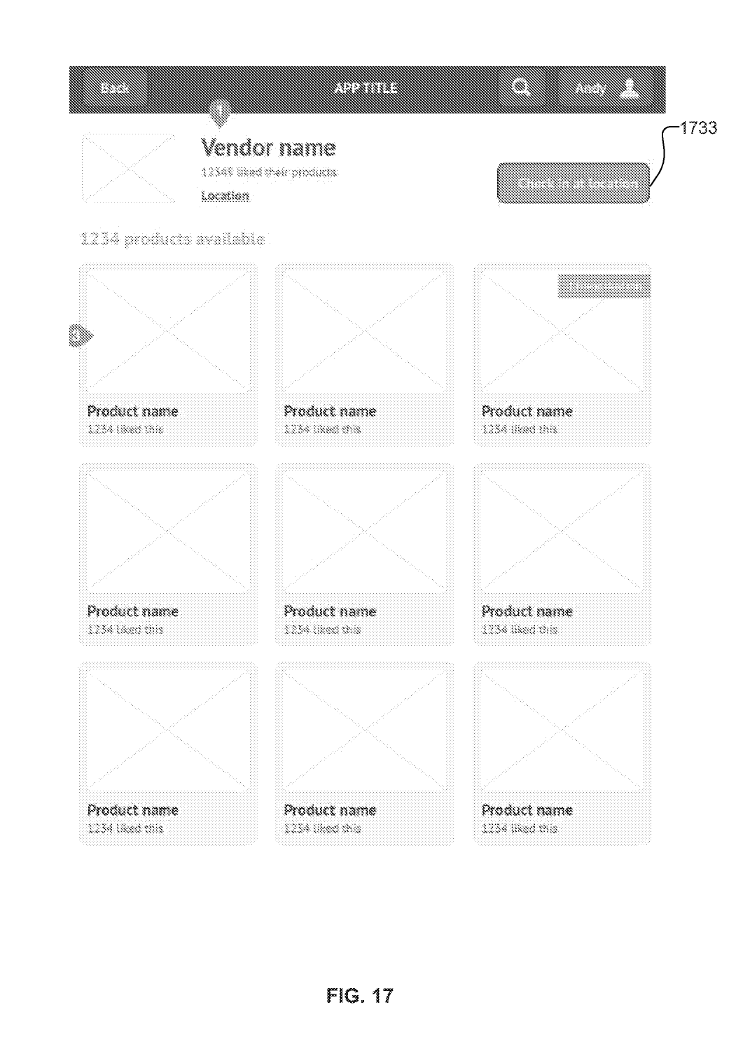

Additionally, the application 160 includes general information about the event such as a map of the exhibition floor, opening hours, driving directions, etc. Buyers can search for vendors. FIG. 15 illustrates a list of all vendors at the event according to one embodiment. Currently the interface is displaying all 1525 vendors at the event. Buyers can filter the list by category 1527 as well as product type 1529. Button 1531 provides a link to a floor plan showing the location of the listed vendors. FIG. 16 illustrates a floor plan of vendor locations according to one embodiment at the location. FIG. 17 illustrates a user interface that shows detail about a particular vendor according to one embodiment. In addition to the vendor's products, the interface provides a button 1733 for the buyer to check-in with the vendor.

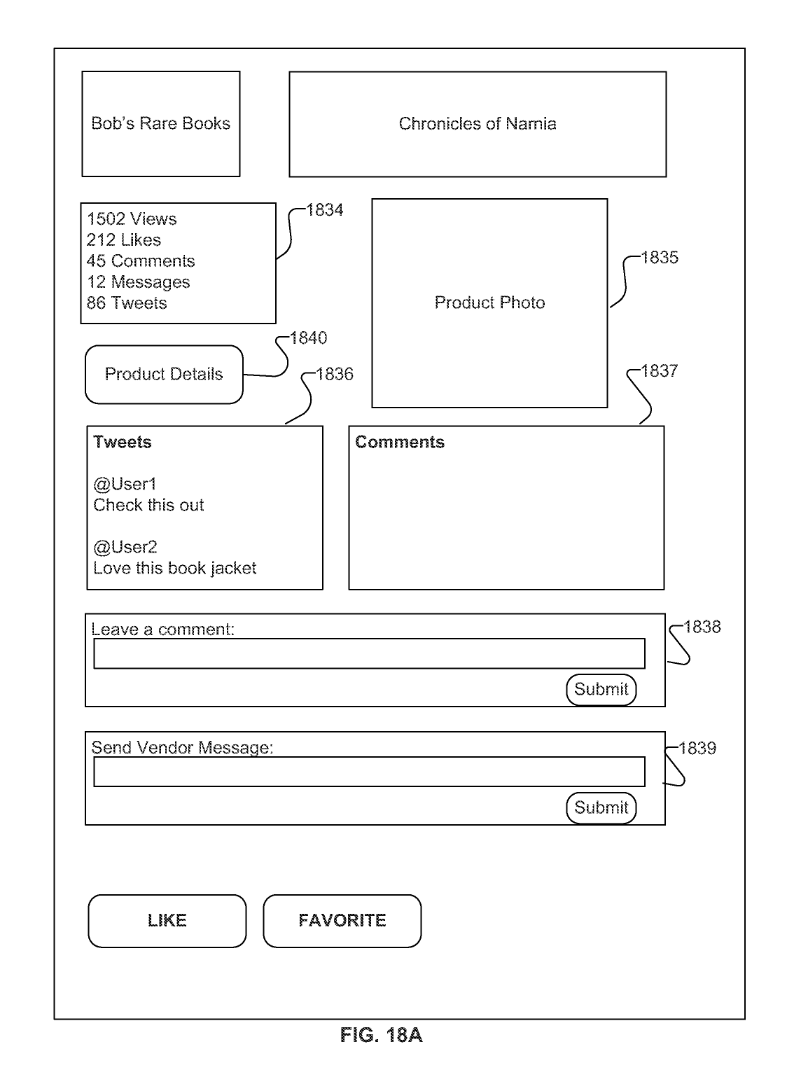

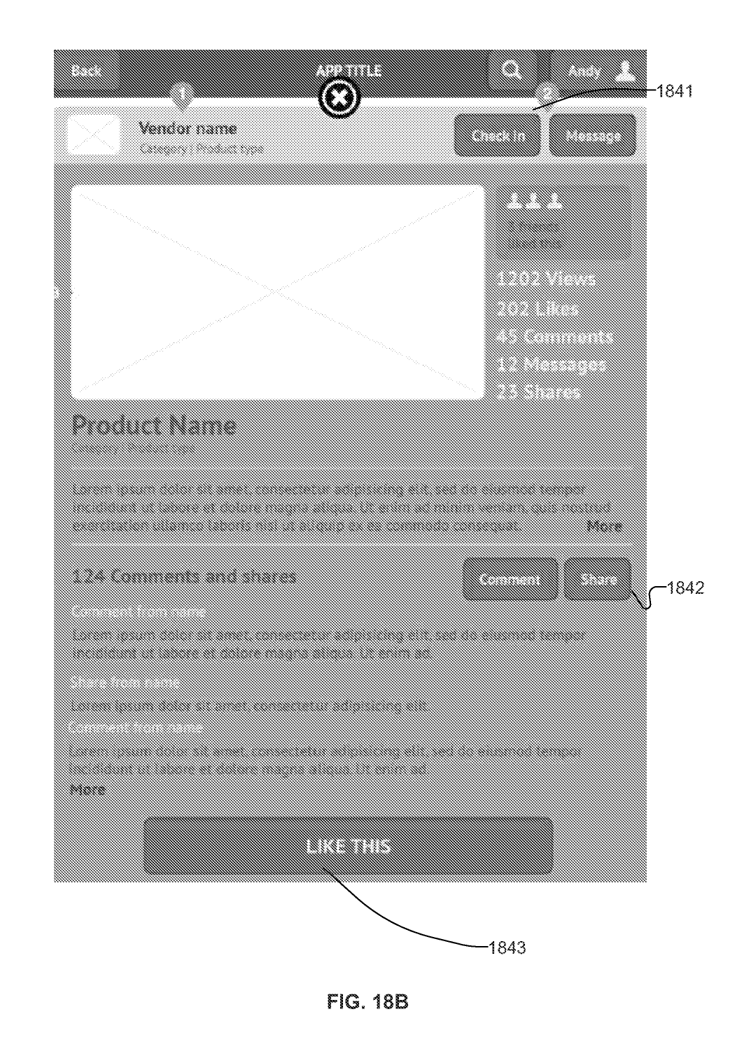

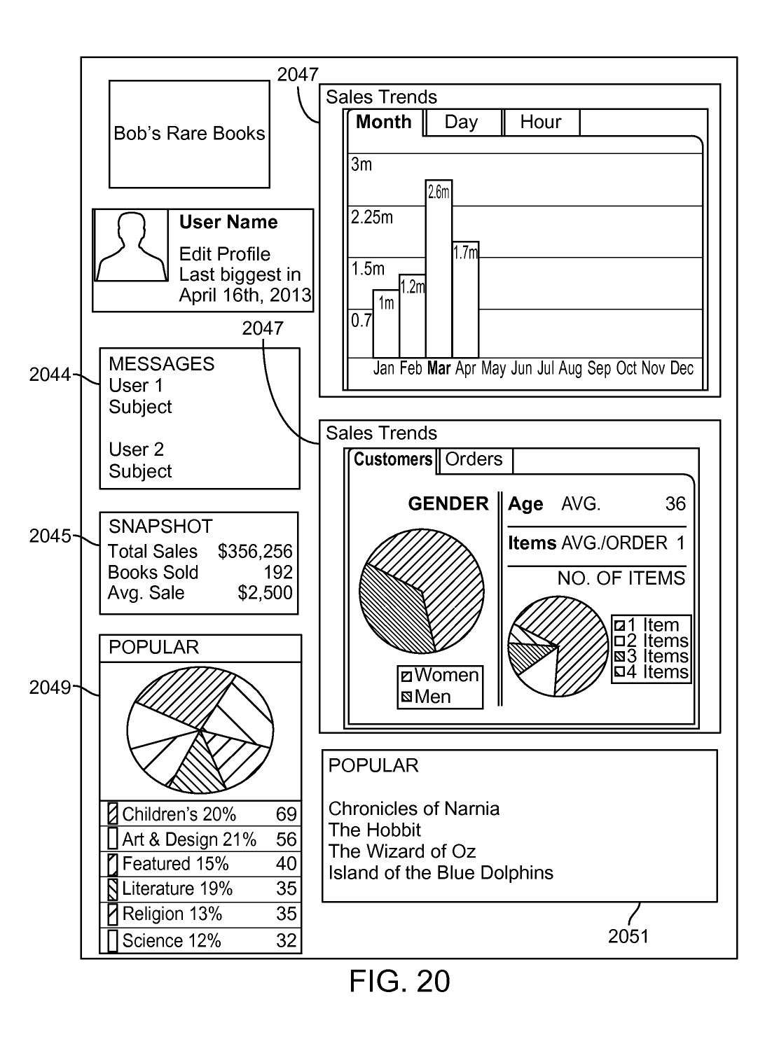

Buyers can see more detail about products offered by the vendors. FIG. 18A illustrates an example interface at a buyer application 160 for the product, Chronicles of Narnia. The view for the buyer also includes a summary 1834 of the interactions with the product by other buyers at the event, a product photo 1835, public tweets 1836 about the product and also comments 1837 left by other buyers at the product's page. The buyer has dialog boxes for leaving comments 1838 on the product's page as well as sending a message 1839 to the vendor. Messages sent appear at the vendor's interface as shown in FIG. 20. As shown in FIG. 18A, there is also a link 1840 to further details about the product. Among the detailed information available may be pricing information for the product and even sample terms and conditions for placing orders. In some embodiments, it will be possible to place an order for the product. Additionally or alternatively the buyer can provide to the vendor a number of products the buyer is planning on ordering but without actually placing the order. This information still provides the vendor with valuable information to forecast demand for the product.

FIG. 18B illustrates a user interface displaying such additional details according to one embodiment. If the buyer has not checked in with the vendor, the user has the option to do so at button 1841. Additionally, share the product 1842 or like 1843 the product. In sharing the product, the buyer can share the product with other buyers at the event, for example, those with whom the buyer is associated either via the buyer's company or via a social networking site.

Buyers can set up appointments, e.g., during the trade show, with particular vendors via the application 160 as well. In an embodiment where the vendor has provided a calendar of available times to the system 100, the arrangement of the appointment can be automatic requiring no approval from the vendor if the buyer's selected time slot is free. If the vendor has not provided a calendar of possible appointment times or if the vendor wants to screen buyers prior to meeting them, the application 160 would send a message to the vendor via the system 100 requesting an appointment. Once an appointment is confirmed, the appointment appears on the buyer's application 160.

### Real-Time Event Data

During the event, the application 160 records a buyer's interactions with the products in the application 160—such as viewing a product, amount of time spent viewing a product, sharing the product with others, commenting on a product, marking the product as a favorite, clicking on the product details, sending a message to the vendor from the product page etc. and provides that interaction data to the event data acquisition module 120 which stores 217 it in the database 130. Additionally, if the buyer's interactions are related to a product in a campaign to which the buyer has been invited, the interaction is marked as related to the campaign and used to assess engagement with the campaign. In some embodiments, the information is provided to the system 100 via custom application programming interface (API) calls. Additionally the application 160 provides to the system 100 the amount of time a buyer uses the application 160—unrelated to any one specific product or feature in the application 160.

Optionally, the client 155 includes a location module that allows the client 155 to retrieve its location (via Wi-Fi triangulation, global positioning system (GPS), etc.) and the client 155 provides the location to the event data acquisition module 120 which matches the provided location to the location of vendor booths. Alternatively, buyers check in at vendor booths manually and traffic at the event is recorded in this manner. A buyer can check in by having a code on a badge worn by the buyer scanned by a vendor client 156 at the booth. Alternatively, a buyer checks in by clicking on a check in button in the application 160 for that vendor or by scanning a code at the vendor booth with the buyer client 155. Examples of codes include one-dimensional and two-dimensional bar codes. A quick response (QR) code is an example of a two-dimensional code. The identity of booths visited by the buyers, date and time of the visit and optionally time spent at a booth is stored in the database 130. In some embodiments, vendors may provide codes for individual products at their booth and buyers can scan those to check in for specific products.

### Data Analysis

In one embodiment, there are three levels of viewing analytics: product, vendor and event. At the event, a listing of trending products and aggregate comment streams are provided to buyers as shown in FIGS. 11-14. Vendors will be presented a private dashboard of their own products. These dashboards will include user-retention statistics for each product and the aggregate. These statistics include demographics of audience which includes gender but also determined influence of the buyers interacting with the vendor's products, buyers' comments, product specific graphs that show trends over the course of the trade show, and ranking of vendor's products. Event coordinators will be able to see a high level view of all the products. This allows the event coordinator to obtain an overview of how the event is doing.

In some embodiments, in carrying out the data analysis open source real time framework Tornado is used. The database is a combination of relational and nosql type to ensure high scalability and availability.

The event data processing module 125 retrieves from the database 130 the stored data received from the buyer application 160 and analyzes 221 the data to determine buyer sentiment for each product and optionally for product lines and vendors. This information is provided to the vendors at vendor client 156 devices giving them useful information about the popularity of their products and how it changes over time during the event. Additionally the even data processing module 125 uses the interactions to estimate sales of the vendor's products and product lines.

A product's popularity is a function of all of the interactions specific to the product. The factors used in determining popularity of a product include: the comments about a product, the number of likes for a product; average amount of time spent on a particular product page; number of check-ins at the booth for the product's vendor; and number of check ins to the product. Each of the interactions is weighted by the demographic information about the buyer the company. Thus interactions by buyers with higher ranking positions at their company are weighted more heavily. Also interactions by buyers from larger companies are weighted more heavily.

In analyzing the comments, the event data processing module 125 determines the number of comments for a product, who posted the comment and analyzes the content of the comment. In analyzing the content of a comment, the length of the comment is determined and the presence or absence of certain keywords is determined. In some embodiments, vendors provide keywords to identify in comments for their products. These may be positive or negative such that the comment is weighted more favorably for the presence of positive keywords and less favorably for the presence of negative keywords. Additionally or alternatively, the comments are analyzed for keywords that are not product specific (e.g., love, hate, beautiful). When one buyer makes multiple comments on a single product, those comments are weighted less heavily. Trending products are determined based on a change over time in a product's popularity. In some embodiments, trending products are determined by a ranking algorithm based on the number of views a product receives, the duration of views and the number of times the product is liked by a buyer.

In one embodiment, the event data processing module 125 creates a dynamic heat map which shows how the population of buyers interacted with the trade show exhibits, e.g., movement through the exhibit during a given day, time spent at specific locations of the trade show exhibits or details on social media interactions at locations at given times at an exhibit. This can show which vendors were popular and at what time periods. The social media interactions and interactions with product pages provide an indication of the circumstances under which a vendor or product is popular. For example, the event data processing module 125 correlates the check ins at a vendor booth with interactions with product pages for that vendor using the time stamps of each. More interactions with product pages for a vendor's products while the buyer is at the vendor booth indicate greater interest by the buyer for the products.

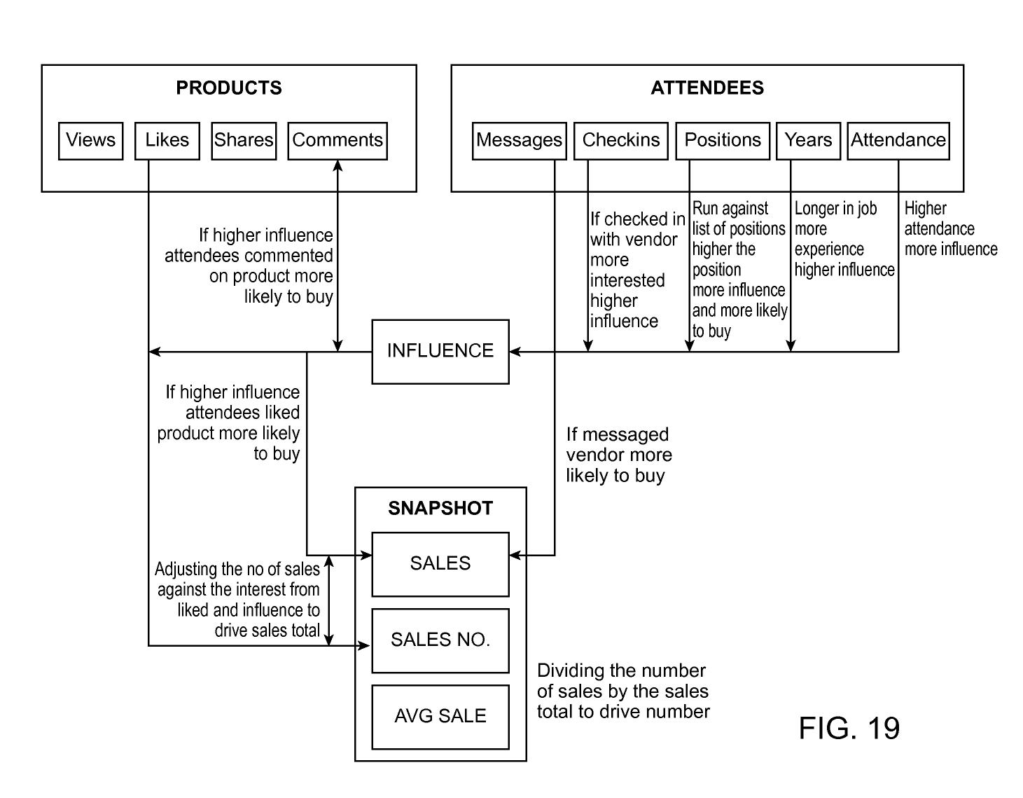

The event data processing module 125 determines vendor specific metrics including potential sales, a combined influence level of buyers interacting with the vendor and the vendor's products, popularity of individual products, categories and product lines. For potential sales, the event data processing module 125 determines a total dollar value, number of potential sales and dollar value of average potential sale. FIG. 19 illustrates the data flow for determination of the vendor specific metrics according to one embodiment.

To determine the influence of a buyer's interactions for a particular product or vendor, the event data processing module 125 retrieves interactions with the vendor and weights them based on the demographic information of the buyer. For example, as shown in FIG. 19, whether a buyer has checked in with a vendor is considered and interactions by buyers who have checked in with the vendor are weighted more heavily. Also the higher the position of the buyer with the buyer's company and/or the longer the buyer has been with the buyer's company, the more weight an interaction is given. In some embodiments, the more tradeshows a buyer has attended, the more weight that buyer's interactions are given as the buyer is considered to be more influential.

In some embodiments, a non-vendor specific influence score is determined for each buyer which is used to weight each buyer's interactions in all subsequent determinations by event data processing module 125 that utilize interactions by buyers. Such an influence score for the buyer is a function of one or more of the buyer's years with the buyer's company, the buyer's title at the buyer's company, the number of trade shows attended by the buyer, and demographic information about the buyer's company including total sales of the company, the company's ranking within its industry, etc. The higher the buyer's rank is within the company and/or the longer the buyer has been with the company, the more influential the buyer is considered. A buyer's influence is higher if the company the buyer is representing is larger, has higher annual sales, and/or is highly ranked within its industry. A buyer's influence is also greater the more tradeshows the buyer has attended—either in total or over a given period of time.

To determine potential sales information for a vendor, the event data processing module 125 retrieves interactions of the buyers with the vendor. In some embodiments, only those messages specific to a product are considered. In other embodiments, all messages (including those not specific to a product) are considered. In some embodiments, a message is considered specific to a product when the message is sent to the vendor from a product-specific page in the buyer application. Additionally, the event data processing module 125 retrieves comments left relevant to the vendor's products as well as “likes” (or selecting a product as a “favorite”). Optionally, all other interactions of the buyer with the vendor are also used. Each of these interactions is optionally weighted according to the influence score for the buyer having the interaction.

In one embodiment the number of potential sales is a function of the likes for a vendor's products—each like optionally weighted with the influence score of the vendor. The potential sales can also be determined per individual product offered by the vendor. In some embodiments, other interactions, optionally weighted with the influence score of the vendor, are also used as part of determining the number of potential sales.

The dollar amount of all potential sales is determined as a function of messages left relevant to the vendor and optionally, just messages relevant to individual products for the vendor. Comments left relevant to the vendor and/or individual vendor products, also optionally weighted with the influence score of the buyer leaving the comment may also be part of the determination of dollar amount of all potential sales. In some embodiments, additional interactions, such as shares, views and likes, optionally weighted with the buyer's influence score, are part of the determination of the dollar amount of potential sales.

In some embodiments, the determination of number of potential sales and dollar amount of all potential sales is determined by a model. The model is created by analyzing prior events and the data collected at those events including the sales that resulted. Using computer learning a model is generated that allows the prediction of a buyer's influence based on various factors as well as then the predicted number of potential sales and dollar amount of all potential sales at a future event.

At the vendor application 161 at the vendor client 156, there is a dashboard that provides the vendor with an overview of incoming data for that vendor's products. The application 161 includes functionalities for drilling down into the statistics. Vendors can create surveys requesting input from buyers on their products. Such surveys can be sent either to all buyers or just to those whose interactions with the vendor exceed a particular threshold or meet vendor-selected criteria. Vendors can issue invitations to special receptions and parties at the event. Like the surveys, those invitations can be sent to all buyers or just those who meet certain criteria.

Features of products can also be customized. For a product such as a couch that comes in various fabric and color options, the received data from the buyers may show which color is most popular, and the vendor can adjust the order of the couches to order more of the popular color and possibly discontinue some colors all together.

The disclosed system and methods are especially beneficial for products which have a long, high-volume sale cycle. This is so because additional and more detailed insight into the predicted market demand for such products can be used because of the long cycle.

Each of the buyer application 160, vendor application 161 and event coordinator application 162, analysis of the event data is provided that is specific to that user's role.

FIG. 20 illustrates an example interface at vendor application 161 providing analysis of event data for a book dealer. The interface provides a mailbox 2044 showing messages received by the vendor, a snapshot 2045 of sales data and trend information 2047. The currently displayed trend information includes a graphic 2049 illustrating the breakdown of popular books by genre as well as individual popular books 2051. Additionally sales data is shown over time. Monthly sales data is currently displayed but the user can click over to daily and hourly sales data. Sales trends by buyer are also displayed showing the gender of buyers and a breakdown of how many items each buyer is purchasing.

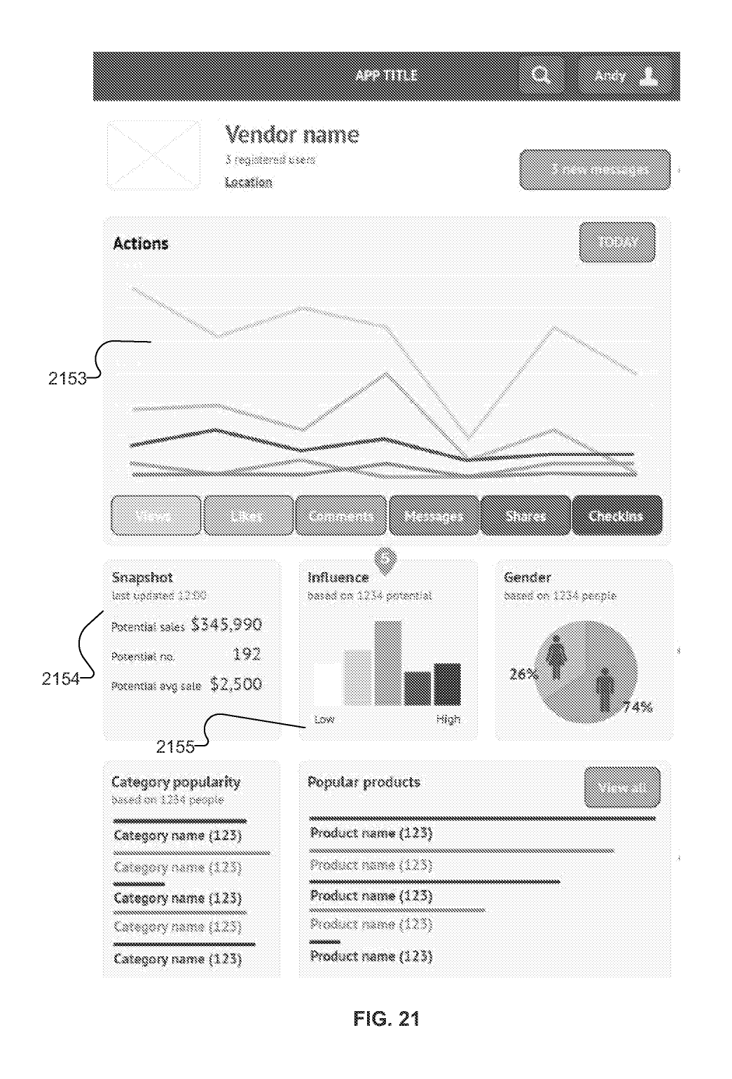

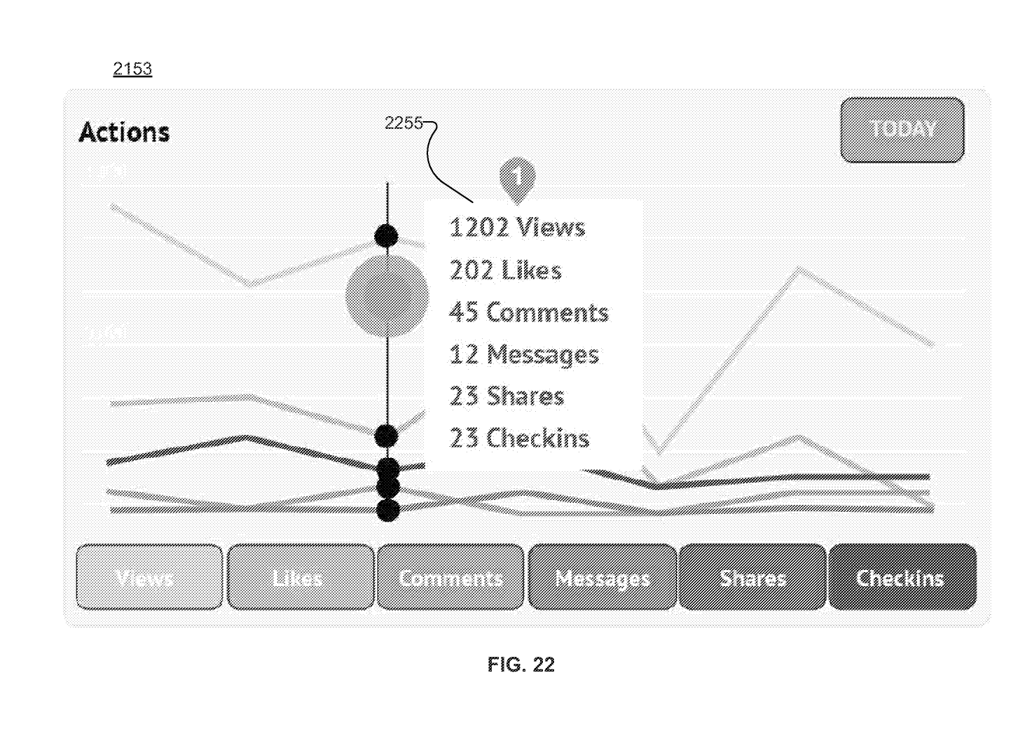

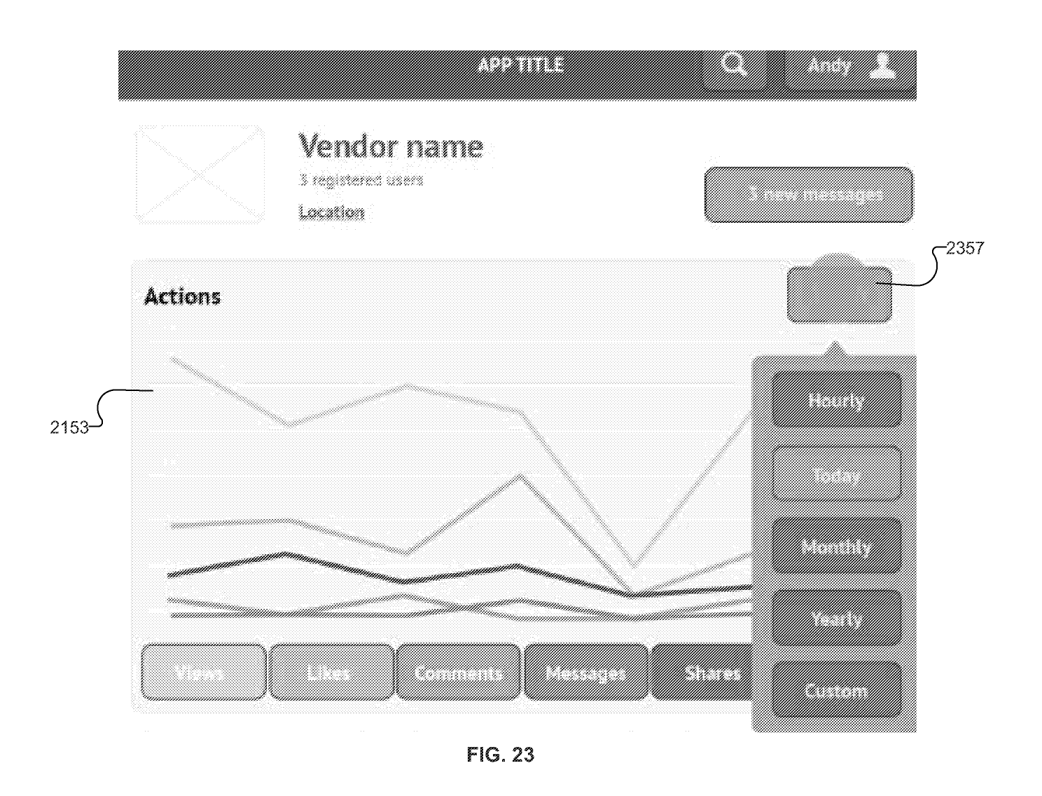

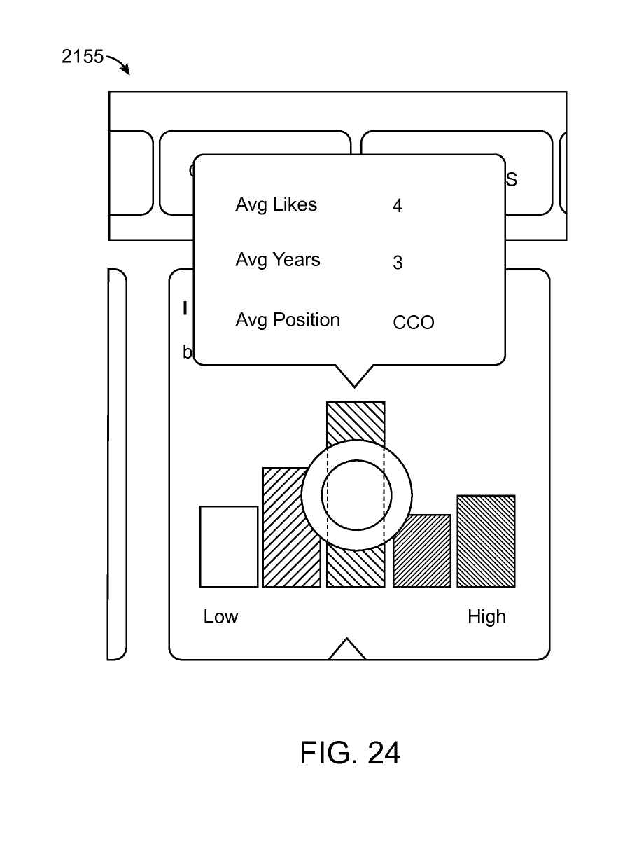

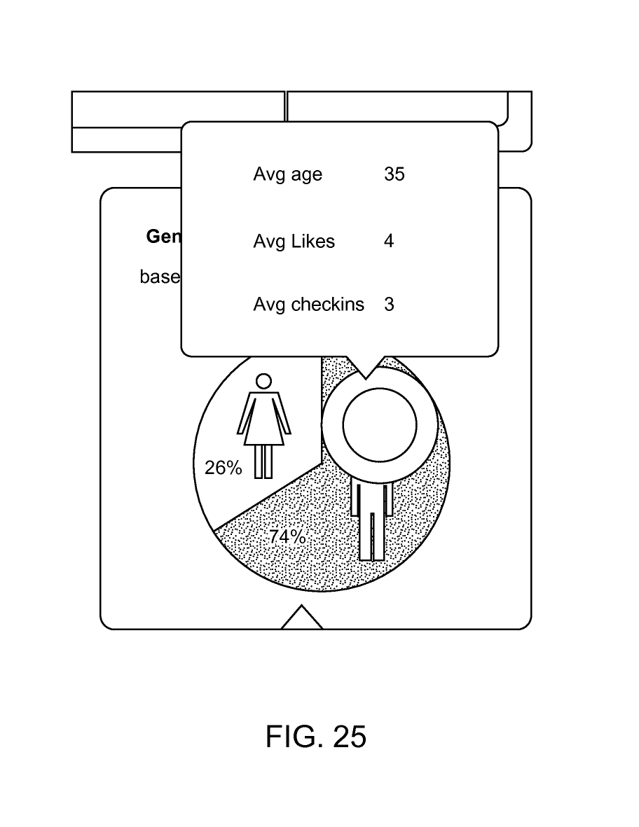

FIG. 21 illustrates another example interface at vendor application 161 providing analysis of event data. This interface includes graph 2153 illustrating buyer interactions with the vendors' products over time and potential sales 2154. Additionally, a breakdown of the influence of the buyers interacting with the vendors' products as determined by event data processing module 125 is shown in graph 2155. FIG. 22 illustrates a more detailed version of graph 2153 showing details of the action in the graph 2153. The drop-down menu 2255 shows the individual interactions that make up that day's datapoint on graph 2153. FIG. 23 illustrates that a user can update graph 2153 to show interactions for different time periods using a dropdown menu accessed via button 2357. FIG. 24 illustrates more detailed information about the interactions that make up each of the bars in graph 2155. FIG. 25 illustrates more detailed information about the interactions by men and women buyers with the vendors' products.

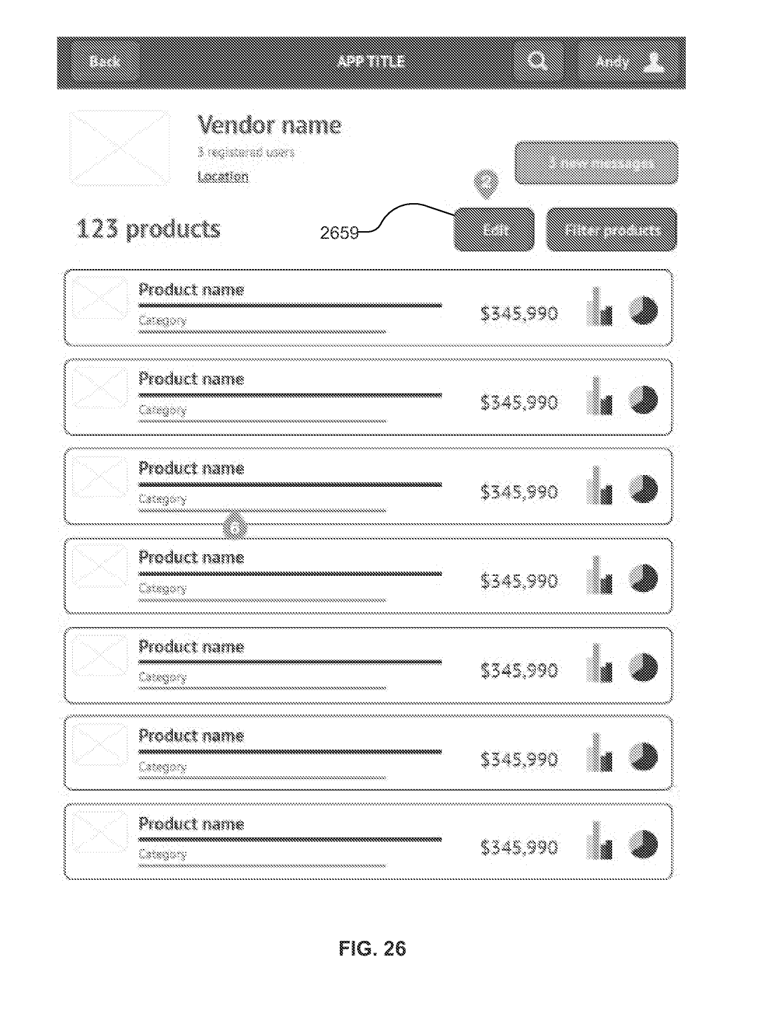

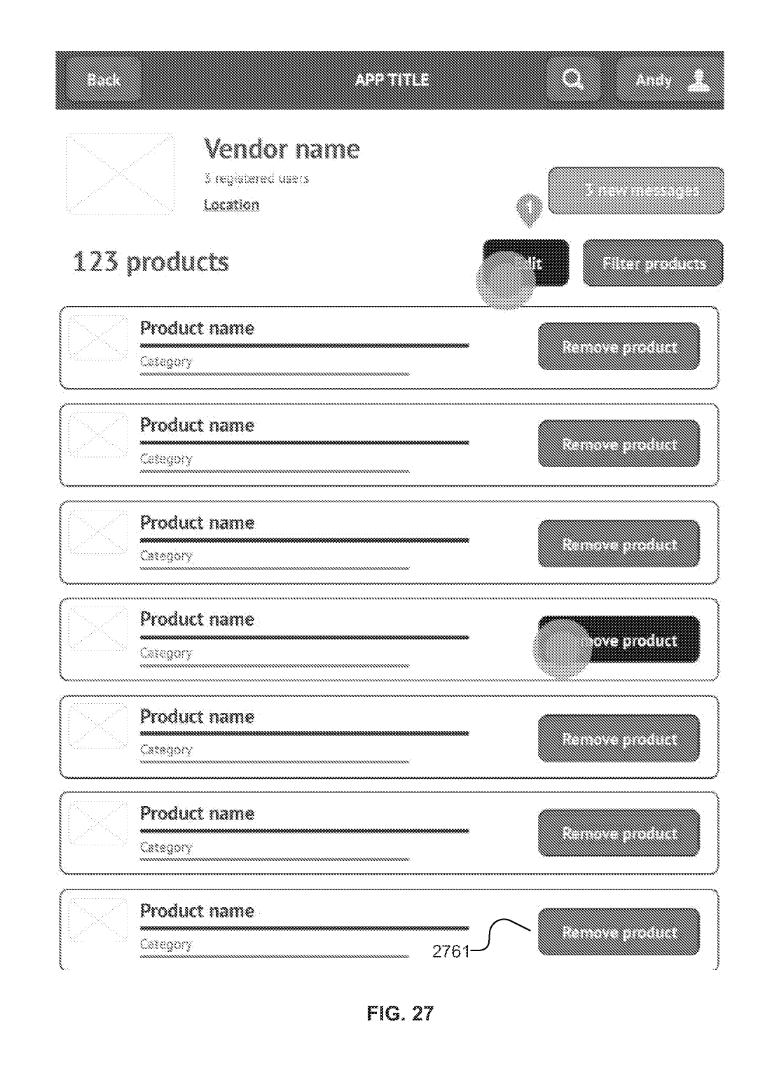

FIG. 26 illustrates a more detailed view of popular products that appears in brief at 2051 in FIG. 20. Vendor users access the ability to edit products in list from button 2659. FIG. 27 illustrates the screen to edit products shown after clicking the edit product button 2659. One of the options for vendors is to remove a product from view by buyers using button 2761.

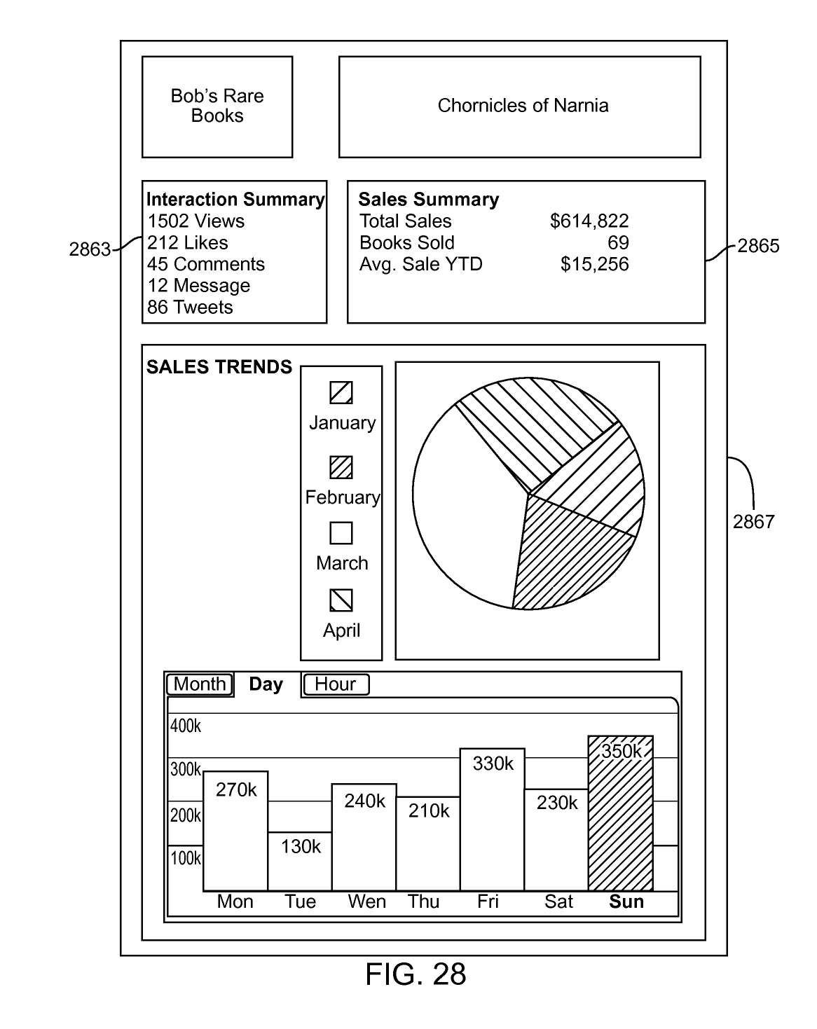

FIG. 28 illustrates an example interface at vendor application 161 providing analysis for a single product, the book, Chronicles of Narnia. The user sees the summary of interactions 2863 at the event by buyers with the product page for the book. There is also a sales summary 2865 as well as sales trends 2867 broken down by various criteria. The page may also include comments submitted by buyers at the book's product page and messages sent by buyers about the book.

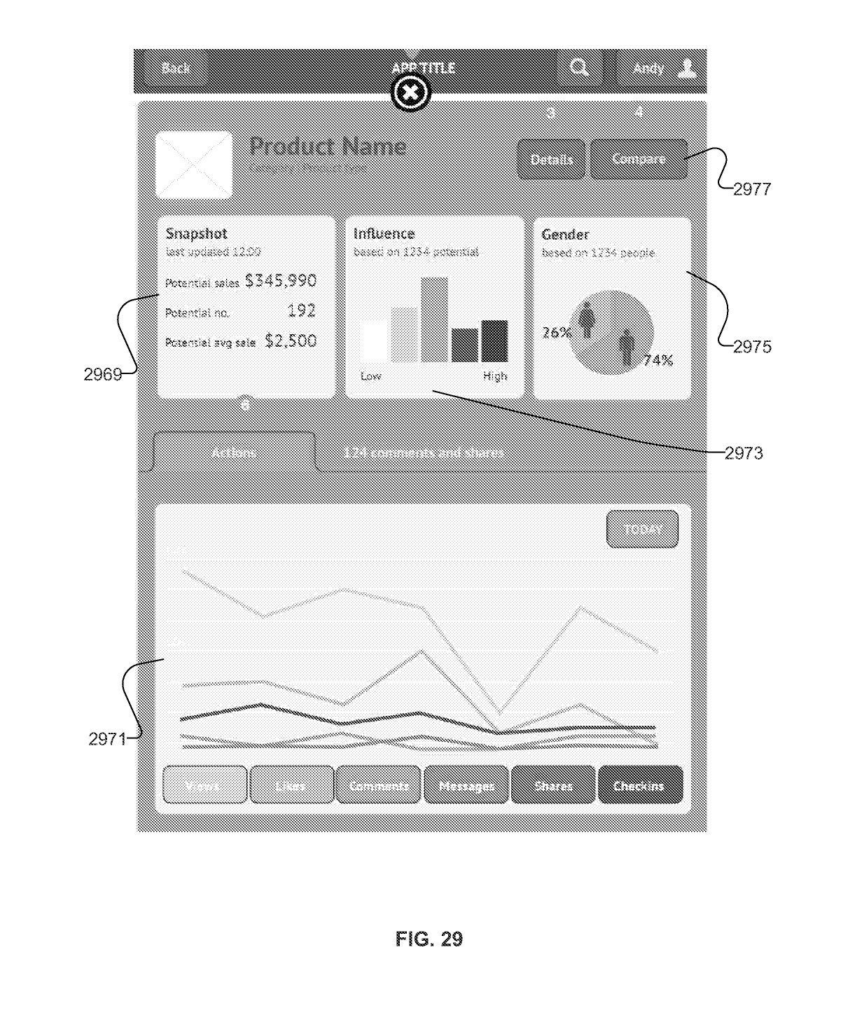

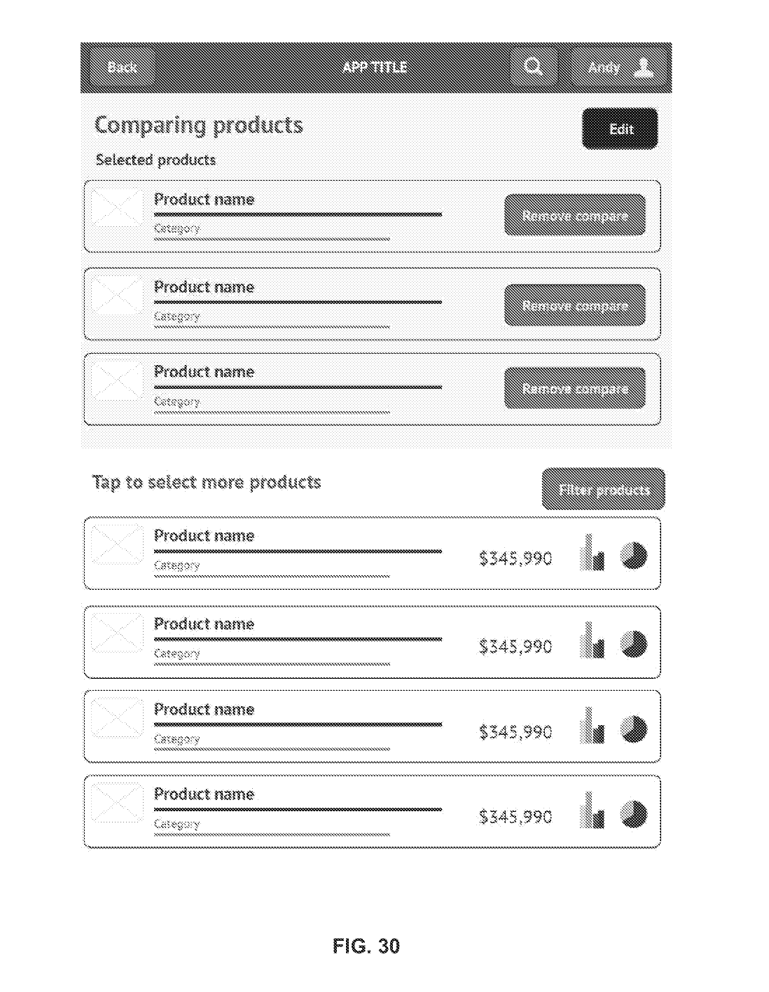

FIG. 29 illustrates a user interface for a vendor user showing detailed data and analysis for one of the vendor's products according to another embodiment. In this embodiment potential sales 2969, trends in buyer interactions 2971, influence of buyers interacting with this product 2973 and the gender breakdown 2975 of buyers interacting with the product. Button 2977 allows the vendor user to compare data of the displayed product to other products. FIG. 30 illustrates the user interface for selecting additional products to compare according to one embodiment.

The disclosed embodiments beneficially allow for determination of the ebb and flow of the popularity of a product. This is useful because a particular product may receive a very large number of views or visits on the first morning of an exhibition and very few thereafter. Looking at the total number of views and visits without seeing the trend over time may lead to the vendor deciding that the product is moderately popular and decide to order accordingly from the manufacturer. In fact, all of the early visits and views were because of pre-event hype and upon actually examining the product there was very little interest so it would be more appropriate to order just a few from the manufacturer or discontinue the product all together.

In another example, a product that started with no interest on the first day and gradually got more and more views over time may end also with a moderate total number of views but the upward trend indicates that the vendor should order more units from the manufacturer than what the moderate total number of views and visits might suggest.

The disclosed system and method was exemplified in reference to a physical trade show at which products are sold. The system and method is also useful for services that have long sales cycles. Examples include but are not limited to vacation packages, resort packages, fractional ownership of expensive items such as airplanes and vacation lodging, etc. Also, it is not necessary for the event to be an in-person trade show. The disclosed system and method are also useful for other types of events that are meetings of buyers and vendors. An example may be a limited time on-line trade show or exhibition at which registered buyers and vendors interact in a similar manner as at a trade show.

### Additional Considerations

The disclosure configurations beneficially allow for real time analysis of interactions by buyers with products giving vendors more information more quickly to be able to respond to predicted changes in demand for goods—either an increase or a decrease are useful to know about as soon as possible.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for analyzing wholesale demand for products through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method performed on a computer for estimating demand for a product comprising:
receiving features of a plurality of products offered for sale;
receiving from a buyer criteria for products to purchase;
preparing for the buyer a list of products offered for sale matching the criteria for products to purchase;
receiving a plurality of interactions of the buyer with products in the list of products offered for sale;
receiving a plurality of demographic information about the buyer; and
determining a demand for the products in the list of products offered for sale based on the received plurality of interactions and the plurality of demographic information.

2. The method of claim 1 wherein the demographic information comprises a number of years the buyer has been employed at an employer.

3. The method of claim 1 wherein the demographic information comprises a title of the buyer at an employer.

4. The method of claim 1 wherein the demographic information comprises demographic information about an employer of the buyer.

5. The method of claim 4 wherein the demographic information about an employer of the buyer comprises a size of the employer.

6. The method of claim 5 wherein the size of the employer comprises a number of employees.

7. The method of claim 5 wherein the size of the employer comprises annual sales of the employer.

8. The method of claim 1 wherein the plurality of interactions comprises the buyer viewing information about a product in the list of products via an application.

9. The method of claim 8 wherein the plurality of interactions further comprises an amount of time spent viewing the information about the product.

10. The method of claim 1 wherein the plurality of interactions comprises an email sent by the buyer to the vendor about a product in the list of products.

11. The method of claim 1 wherein the plurality of interactions comprises a comment left by the buyer at a user interface displaying a product in the list of products about the product.

12. The method of claim 1 wherein determining a demand for the products comprises determining a number of projected sales for at least one of the products in the list of products.

13. The method of claim 1 wherein determining a demand for the products comprises determining an amount of projected revenue from sales of at least one of the products in the list of products.

14. A method performed on a computer for estimating demand for a product comprising:
receiving a plurality of interactions of a buyer with products in a list of products offered for sale;
receiving a plurality of demographic information about the buyer; and
determining a demand for the products in the list of products offered for sale based on the received plurality of interactions and the plurality of demographic information.

15. The method of claim 14 wherein the demographic information comprises a number of years the buyer has been employed at an employer.

16. The method of claim 14 wherein the demographic information comprises a title of the buyer at an employer.

17. The method of claim 14 wherein the demographic information comprises demographic information about an employer of the buyer.

18. The method of claim 17 wherein the demographic information about an employer of the buyer comprises a size of the employer.

19. The method of claim 18 wherein the size of the employer comprises a number of employees.

20. The method of claim 18 wherein the size of the employer comprises annual sales of the employer.
